(19) United States
(12) Patent Application Publication
(10) Pub. No.: US 2011/0026791 A1
(43) Pub. Date: Feb. 3, 2011

(54) SYSTEMS, COMPUTER-READABLE MEDIA, AND METHODS FOR CLASSIFYING AND DISPLAYING BREAST DENSITY

(75) Inventors: Michael J. Collins, Beavercreek, OH (US); Hrishikesh Haldankar, Fairborn, OH (US); Brent Woods, Fairborn, OH (US); Ryan McGinnis, Tipp City, OH (US); Kevin Woods, Beavercreek, OH (US)

Correspondence Address: FOLEY HOAG, LLP;PATENT GROUP, WORLD TRADE CENTER WEST, 155 SEAPORT BLVD, BOSTON, MA, 02110, US

(73) Assignee: iCAD, Inc.

(21) Appl. No.: 12/533,952

(22) Filed: Jul. 31, 2009

Related U.S. Application Data
(63) Continuation-in-part of application No. 12/511,701, filed on Jul. 29, 2009.

(51) Int. Cl. G06K 9/00

(52) U.S. Cl. 382/131

(57) ABSTRACT

Systems, computer-readable media, methods, and a medical imaging system are presented that compute and output a density estimate of a breast. The density estimate may be computed using information from at least two digital images, wherein each image represents a view of at least a portion of the breast from a different specific angle. The density estimate may be computed using information from at least one digital breast image and at least one digital opposite breast image, wherein the at least one digital breast image represents a view of at least a portion of the breast from a specific angle and wherein the at least one digital opposite breast image represents a view of at least a portion of the opposite breast. The density estimate may be computed using computed parenchyma information, the parenchyma information being computed using texture information and density information derived from at least one digital image of at least a portion of the breast. The density estimate may be computed using computed parenchyma information, the parenchyma information being computed from at least one digital image using computed vessel line information, the computed vessel line information being computed from the at least one digital image.

### CLAIM OF PRIORITY

This application is a continuation-in-part of U.S. Ser. No. 12/511,701 filed on Jul. 29, 2009, the entire contents of which are herein incorporated by reference in their entirety.

### FIELD

This application discloses systems, computer-readable media, and methods for the automated analysis and display of images of an anatomical breast to assist a human physician in the inspection of such images.

### BACKGROUND

According to “Recent Advances in Breast Imaging, Mammography, and Computer-Aided Diagnosis of Breast Cancer”, SPIE Press, Bellingham, Wash., 2006, breast cancer is the most common type of cancer in women worldwide. While mammography coupled with physical examination is the current standard for breast cancer screening, one in five breast cancers may be missed by mammography screening, and when suspicious lesions are found and referred to biopsy, about four in five biopsies may turn out to be benign (i.e., “false positives”) and were thus arguably unnecessary. Mammography is the process of using low-dose amplitude-X-rays to examine the human breast. Missed detections and false positives may be attributed to several factors including poor image quality, improper patient positioning, inaccurate interpretation, fibro-glandular tissue obscuration, subtle nature of radiographic findings, eye fatigue, and/ or oversight.

Breast density has been acknowledged to be a factor in effective mammogram interpretation. For example, there is a consideration that mammographic imaging techniques are less successful with denser breast tissue than with predominantly fat breast tissue. Fibro-glandular tissue in dense breasts tend to attenuate x-rays to a greater degree than does fat tissue, leading to increased difficulty in detection of cancer sites for denser breasts. There may also be a strong correlation between breast tissue density and the risk of developing breast cancer. Thus, accurate classification of breast density is required for effective mammogram interpretation. Automated techniques for classifying breast density may be beneficial to radiologists, not only as a means for interpreting mammograms, but as an aid in establishing a strategy for follow-up care (e.g., additional imaging exams, biopsies, etc.).

Accurately determining the density of an anatomical breast can be a challenging task for a computer system due to the wide range of types of breasts that may be encountered in a clinical setting. While some breasts are heterogeneous (i.e., exhibiting a mixture of dense and fat tissue), many other breasts are homogeneous (i.e., exhibiting predominantly dense or predominantly fat tissue). (An example of such a breast is shown in FIGS. 3A and 3B). Certain breasts may contain anomalies that mimic normal breast tissue such as bright markers, large cancers, implants, blood vessels, etc., and therefore that can cause errors in breast density estimation. This challenge may be further compounded depending on the granularity with which the computer system reports breast density information. While many prior art computer systems may compute and report breast density as either fat or dense, emerging computer systems may compute and report breast density according to the American College of Radiology BIRADS (Breast Imaging Reporting and Data System), which consists of four classes: entirely fat; scattered fibroglandular densities; heterogeneously dense; and extremely dense.

### SUMMARY

In view of the foregoing, various embodiments of the present disclosure are directed to methods for classifying and displaying breast density.

In particular, in a computer system comprising at least one processor, at least one input device, and at least one output device, a method of computing and outputting a density estimate of a breast, comprises: obtaining, by means of at least one input device, at least two digital images of at least a portion of the breast, wherein each image represents a view of at least a portion of the breast from a specific angle; computing, in at least one processor, a breast density estimate using information from the at least two digital images; and outputting, by means of at least one output device, the computed density estimate.

Computing the breast density estimate may comprise in at least one processor, for each digital image, computing at least one feature value; in at least one processor, for each digital image, computing an image breast density estimate using computed image feature values; and in at least one processor, computing the breast density estimate using computed image breast density estimates. At least one digital image may be a two-dimensional CC digital image and at least one digital image may be a two-dimensional MLO digital image; and at least one image breast density estimate may be computed by means of a cranio-caudal (CC) computer-based classifier, using computed image feature values of a CC digital image, and at least one image breast density estimate may be computed by means of a medio-lateral oblique (MLO) computer-based classifier, using computed image feature values of a MLO digital image. The CC computer-based classifier may comprise feature values that distinguish breasts of different densities projected from a cranio-caudal angle and the MLO computer-based classifier may comprise feature values that distinguish breasts of different densities projected from a medio-lateral oblique angle. At least two digital images of the breast may be tomographic images and each image breast density estimate may be computed by means of a tomographic image computer-based classifier, using computed image feature values of a tomographic digital image. Each tomographic computer-based classifier may comprise feature values that distinguish breasts of different densities projected from a specific tomographic angle. Computing the breast density estimate may comprise, in at least one processor, for each digital image, computing at least one feature value; and in at least one processor, computing the breast density estimate using computed image feature values. Computing the breast density estimate may further comprise using information from at least one digital image of at least a portion of a breast opposite to the breast. At least one digital image may represent a two-dimensional CC view of at least a portion of the breast, and at least one digital image may represent a two-dimensional MLO view of at least a portion of the breast. The images may be a plurality of tomographic images of at least a portion of the breast. The computed density estimate may comprise an estimate of whether the breast belongs to at least one of four predetermined breast density categories of entirely fatty, scattered fibro-glandular dense, heterogeneously dense, and extremely dense breasts.

In a computer system having at least one input device, at least one processor and at least one output device, a method of computing and outputting a density estimate of a breast comprises: obtaining, by means of at least one input device, at least one digital image of at least a portion of the breast, wherein each image represents a view of at least a portion of the breast from a specific angle; obtaining, by means of at least one input device, at least one digital image of at least a portion of a breast opposite to the breast, wherein each image represents a view of at least a portion of the opposite breast from a specific angle; computing, in at least one processor, a breast density estimate using information from the at least one digital breast image and at least one digital opposite breast image; and outputting, by means of at least one output device, the computed density estimate.

Computing the breast density estimate may comprise: in at least one processor, for each digital breast image, computing at least one feature value using the said digital breast image and a digital opposite breast image; in at least one processor, for each digital breast image, computing an image breast density estimate using computed image feature values; and in at least one processor, computing the breast density estimate using computed image breast density estimates. Computing the breast density estimate may comprise: in at least one processor, for each digital breast image, computing at least one feature value using the said digital breast image and a digital opposite breast image; and in at least one processor, computing the breast density estimate using computed image feature values. An asymmetrical subtraction of information relating to the digital opposite breast image from information relating to the digital breast image may be performed. At least one digital breast image may represent a two-dimensional CC view of at least a portion of the breast, and at least one digital breast image may represent a two-dimensional MLO view of at least a portion of the breast. The digital breast images may be tomographic images of at least a portion of the breast. The computed density estimate may comprise an estimate of whether the breast belongs to at least one of four predetermined breast density categories of entirely fatty, scattered fibro-glandular dense, heterogeneously dense, and extremely dense breasts.

A medical imaging system comprises: a source configured to obtain digital images of breasts; a processor coupled with the source configured to compute a density estimate of a breast using information from at least two digital images, wherein a first digital image represents a view of at least a portion of the breast from a specific angle and wherein a second digital image is chosen from a group consisting of a further view of at least a portion of the breast from a second specific angle, and a view of at least a portion of an opposite breast from the specific angle; and an output device coupled with the processor configured to output the computed density estimate.

The source may be configured to obtain a plurality of tomographic images of at least a portion of the breast and the processor may be configured to compute the density estimate using tomographic images. The processor may be further configured to compute a plurality of reconstructed slices from the plurality of tomographic images and to compute the density estimate using reconstructed slices.

In a computer system having at least one input device, at least one processor and at least one output device, a method of computing and outputting a density estimate of a breast comprises: obtaining, by means of at least one input device, at least one digital image of at least a portion of the breast; computing, in at least one processor, parenchyma information relating to the breast using texture information and density information derived from the at least one digital image; computing, in at least one processor, a breast density estimate using computed parenchyma information; and outputting, by means of at least one output device, the computed density estimate.

The parenchyma information may be computed for individual pixels of the digital image. Parenchyma information for a specific area of the breast may be computed based in part on the location of the area in the breast. Density information may be given a stronger weighting than texture information in computing parenchyma information. Parenchyma information may be computed further using texture information and density information derived from at least one digital image of at least a portion of an opposite breast. A digital representation of at least a portion of the breast may be segmented into breast parenchyma and breast non-parenchyma using computed parenchyma information. The digital representation may be segmented by thresholding the computed parenchyma information. The breast density estimate may be computed using feature values of segmented breast parenchyma. The breast density estimate may be computed further using feature values of segmented breast non-parenchyma. The breast density estimate may be computed using feature values of computed parenchyma information. The computed density estimate may comprise an estimate of whether the breast belongs to at least one of four predetermined breast density categories of entirely fatty, scattered fibro-glandular dense, heterogeneously dense, and extremely dense breasts.

In a computer system having at least one input device, at least one processor and at least one output device, a method of computing and outputting a density estimate of a breast comprises obtaining, by means of at least one input device, at least one digital image of at least a portion of the breast; computing, in at least one processor, vessel line information from the at least one digital image; computing, in at least one processor, parenchyma information from the at least one digital image, using computed vessel line information; computing, in at least one processor, a breast density estimate using computed parenchyma information; and outputting, by means of at least one output device, the computed density estimate. Parenchyma information may be computed by means of treating computed vessel line information as non-parenchyma.

Other aspects of the present disclosure are computer-readable media having computer-readable signals stored thereon. The computer-readable signals define instructions which, as a result of being executed by a computer or computer system, instruct the computer or computer system to perform one or more of the methods disclosed herein. That is to say, the computer-readable medium has the said instructions stored therein.

Yet other aspects of the present disclosure are computers or computer systems having at least one processor, at least one input device, and at least one output device. The computers or computer systems may include or may facilitate the use of computer-readable media with instructions stored therein which, as a result of being executed by the computers or computer systems, instruct the computer or computer system to perform one or more of the methods disclosed herein.

It should be appreciated that all combinations of the foregoing concepts and additional concepts discussed in greater detail below are contemplated as being part of the inventive subject matter disclosed herein.

### BRIEF DESCRIPTION OF THE DRAWINGS

FIG. 1 is a block diagram of an illustrative system for acquiring and processing digital mammographic imagery in accordance with the methods disclosed herein.

FIG. 2 is a flowchart showing a method that may be performed on digital mammography imagery to automatically estimate breast density.

FIG. 3A illustrates an example of a craniocaudal (CC) image routinely acquired in screening mammography.

FIG. 3B illustrates an example of a mediolateral oblique (MLO) image routinely acquired in screening mammography.

FIG. 4 is a flowchart showing an automated method that may be performed to measure the density of an anatomical breast under study in accordance with certain embodiments of the system and methods disclosed herein.

FIG. 5 illustrates one example of a margin corrected MLO image of an anatomical breast under study further illustrating a pectoral muscle mask.

FIG. 6A is a CC image example of a mostly dense breast.

FIG. 6B is a MLO image example of a mostly dense breast.

FIG. 7A is a CC image example of a mostly fatty breast.

FIG. 7B is a MLO image example of a mostly fatty breast.

FIG. 8 is a flowchart showing the automated method steps that may be performed to form a tissue map of the anatomical breast under study in accordance with certain embodiments of the system and methods disclosed herein.

FIG. 9 illustrates an example of a texture map that may be formed in accordance with certain embodiments of the system and methods disclosed herein.

FIG. 10 illustrates an example of a background intensity value estimation map that may be formed in accordance with certain embodiments of the system and methods disclosed herein.

FIG. 11 illustrates an example of an intensity difference map that may be formed in accordance with certain embodiments of the system and methods disclosed herein.

FIG. 12 illustrates an example of a density map that may be formed in accordance with certain embodiments of the system and methods disclosed herein.

FIG. 13 illustrates an example of a re-weighted texture map that may be formed in accordance with certain embodiments of the system and methods disclosed herein.

FIG. 14 illustrates an example of a re-weighted density map that may be formed in accordance with certain embodiments of the system and methods disclosed herein.

FIG. 15 illustrates an example of a probability map that may be formed in accordance with certain embodiments of the system and methods disclosed herein.

FIG. 16 illustrates an example of a tissue map that may be formed in accordance with certain embodiments of the system and methods disclosed herein.

FIG. 17 is a flowchart showing an automated method that may be performed to classify the density of an anatomical breast under study using information from a plurality of images in accordance with another embodiment of the system and methods disclosed herein.

FIG. 18 is a flowchart showing an automated method that may be performed to classify the density of an anatomical breast under study using breast density classification information extracted from individual images in accordance with another embodiment of the system and methods disclosed herein.

FIGS. 19A and 19B are examples of anatomical breast imagery and breast density classification information that may be output in accordance with certain embodiments of the system and methods disclosed herein.

### DETAILED DESCRIPTION OF EMBODIMENTS

In the following detailed description of embodiments, reference is made to the accompanying drawings that form a part hereof, and in which are shown, by way of illustration and not by way of limitation, specific embodiments in which the methods and systems disclosed herein may be practiced. It is to be understood that other embodiments may be utilized and that logical, mechanical, and electrical changes may be made without departing from the scope of the methods and systems disclosed herein.

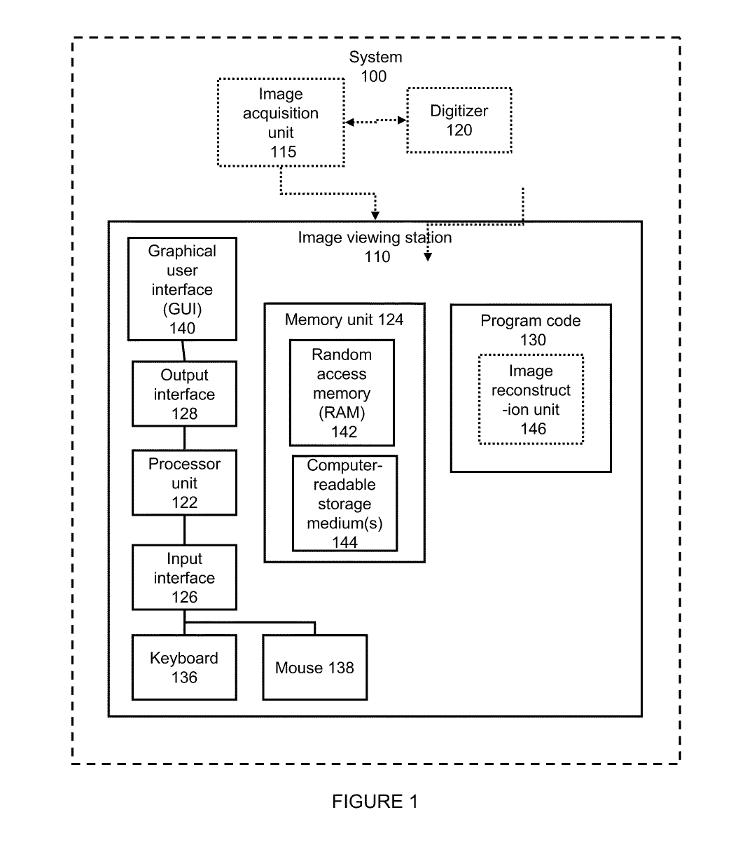

This disclosure is directed to computer systems, computer-readable media, and methods for the automated classification and display of breast density in digital mammographic imaging. FIG. 1 is a block diagram of an illustrative system 100 for acquiring and processing digital mammographic imagery in accordance with the methods disclosed herein. More specifically, system 100 may be suitable for automatically classifying and outputting the density of an anatomical breast by processing digital mammographic imagery in accordance with the various methods disclosed herein. The system described is for reference purposes only. Other systems may be used in carrying out embodiments of the methods disclosed herein.

System 100 of FIG. 1 includes an image viewing station 110 for processing and outputting medical breast imagery and breast density classification information that may be automatically derived from the medical breast imagery in the form of data to a physician or other user of the system. In certain embodiments, system 100 may further include an image acquisition unit 115 for acquiring medical image data by performing an imaging procedure of a patient's anatomical breast. In such a configuration, image acquisition unit 115 is considered to be an input device to system 100. Alternatively, image acquisition unit 115 may connect to and communicate with image viewing station 110 via any type of communication interface, including but not limited to, physical interfaces, network interfaces, software interfaces, and the like. In such configurations, the interface is considered to be an input device to system 100 and will acquire the medical image data. The communication may be by means of a physical connection, or may be wireless, optical or of any other means. It will be understood by a person of skill in the art that image viewing station 110 and image acquisition unit 115 may be deployed as parts of a single system or, alternatively, as parts of multiple, independent systems, and that any such deployment may be utilized in conjunction with embodiments of the methods disclosed herein. If image viewing station 110 is connected to image acquisition unit 115 by means of a network or other direct computer connection, the network interface or other connection means may be the input device for image viewing station 110 to receive imagery for processing by the methods and systems disclosed herein. Alternatively, image viewing station 110 may receive images for processing indirectly from image acquisition unit 115, as by means of transportable storage devices (not shown in FIG. 1) such as but not limited to CDs, DVDs or flash drives, in which case readers for said transportable storage devices may function as input devices for image viewing station 110 for processing images according to the methods disclosed herein. In yet other embodiments, the images for processing may be acquired from storage devices by means of a network or direct physical connection, and the said network or other interface may serve as the input device.

Image acquisition unit 115 is representative of a system capable of acquiring digital mammographic images of anatomical breasts and, in certain embodiments, capable of transmitting digital data representing such mammographic images to image viewing station 110 for further processing. For example, image acquisition unit 115 may be a computed radiographic (CR) mammography system such as those offered by the AGFA Healthcare of Ridgefield Park, N.J. (AGFA); or Fujifilm Medical Systems of Stamford, Conn. (Fuji); a digital radiographic (DR) mammography system such as those offered by the General Electric Company of Fairfield, Conn, (GE); or a tomographic mammography system, such as a digital breast tomosynthesis (DBT) imaging system offered by GE; Hologic, Inc. of Bedford, Mass. (Hologic); or Siemens AG of Munich, Germany (Siemens).

In certain embodiments, image acquisition unit 115 may connect to and communicate with a digitizer apparatus 120, such as a laser scanner with approximately 50 micron resolution, for digitizing developed x-ray mammograms of anatomical breasts. Such x-ray mammograms may be produced as films by image acquisition unit 115 and require digitizing prior to the execution of the methods disclosed hereinbelow by image viewing station 110. Image acquisition unit 115 and/or image viewing station 110 may connect to and communicate with digitizer apparatus 120 via any type of communication interface as described hereinabove. In such embodiments, the interface may function as the input device through which is obtained the digitized image for processing by the methods described herein.

Image viewing station 110 is representative of a general purpose computer system containing instructions for analyzing the medical breast imagery and outputting the medical imagery and/or breast density classification information that may be automatically derived from the medical breast imagery in the form of data. Image viewing station 110 may further comprise a processor unit 122, a memory unit 124, an input interface 126, an output interface 128, and program code 130 containing instructions that can be read and executed by the station. Input interface 126 may connect processor unit 122 to an input device such as a keyboard 136, a mouse 138, a means for acquiring the images for processing as described hereinabove, and/or another suitable device as will be known to a person of skill in the art, including for example and not by way of limitation a voice-activated system. Thus, input interface 126 may allow a user to communicate commands to the processor as well as to acquire images. One such exemplary command is the execution of program code 130 tangibly embodying the automated breast density classification methods disclosed herein. Output interface 128 may further be connected to processor unit 122 and an output device such as a graphical user interface (GUI) 140. Thus, output interface 128 may allow image viewing station 110 to transmit data from the processor to the output device, one such exemplary transmission including medical imagery and breast density classification data for display to a user on GUI 140.

Memory unit 124 may include conventional semiconductor random access memory (RAM) 142 or other forms of memory known in the art; and one or more computer readable-storage mediums 144, such as a hard drive, floppy drive, read/write CD-ROM, tape drive, flash drive, optical drive, etc. Stored in program code 130 may be an image reconstruction unit 146 for constructing additional imagery from the images acquired by image acquisition unit 110 in accordance with certain embodiments of the methods disclosed herein. While image reconstruction unit 146 is depicted as being a component within image viewing station 120, one skilled in the art will appreciate that image reconstruction unit 146 may also be deployed as part of one or more separate computers, computer processors, or computer systems. For example, image reconstruction unit 146 may be deployed as part of a review workstation system that constructs additional tomographic breast imagery from direct projections acquired by a DBT imaging system. One example of a review workstation system that performs such acts is the DexTop Breast Imaging Workstation, offered by Dexela Limited, London, United Kingdom.

While image viewing station 110, image acquisition unit 115, and digitizer apparatus 120 are depicted as being separate components within system 100, one skilled in the art will appreciate that any combination of such components may be deployed as parts of a single computer, computer processor, and/or computer system.

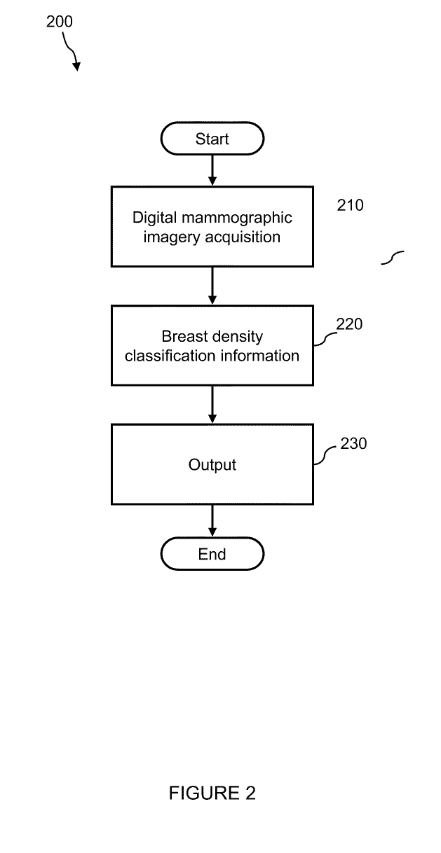

Referring now to FIG. 2, at digital mammographic imagery acquisition step 210, digital mammographic imagery of an anatomical breast under study may be acquired by image viewing station 110 in digital form by means of any of the input devices described above, or any other input device as will be known to a person of skill in the art. In embodiments in which an image acquisition unit 115 may be included in system 100, suitable digital mammographic imagery may be acquired by operating image acquisition unit 115 to image a patient's anatomical breast and then transmit the acquired image data to image viewing station 110. Alternatively, image acquisition unit 115 may acquire one or more film x-rays of the anatomical breast under study and the film x-rays may be converted into digital mammographic imagery using digitizer apparatus 120. In other embodiments, suitable digital mammographic imagery for digital mammographic imagery acquisition step 210 may be retrieved from storage in memory unit 124 or from storage in a memory unit residing outside of image acquisition unit 115 via a communication interface.

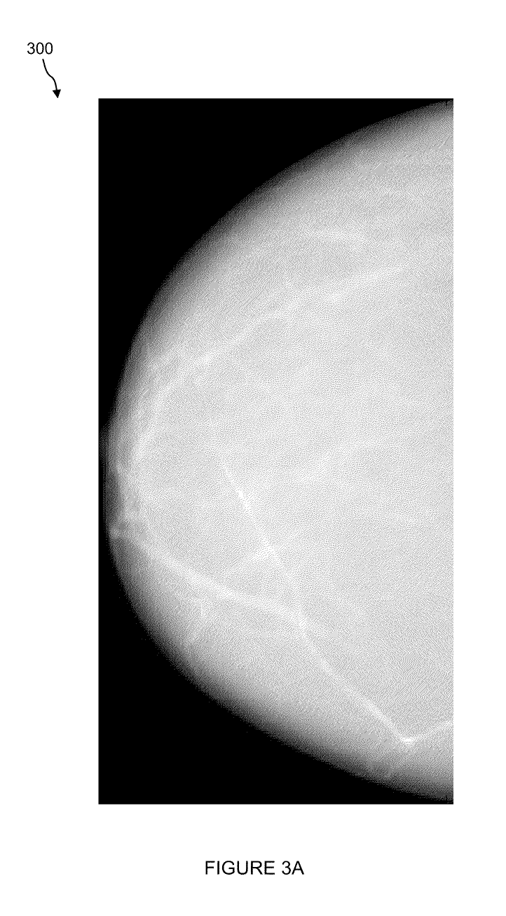

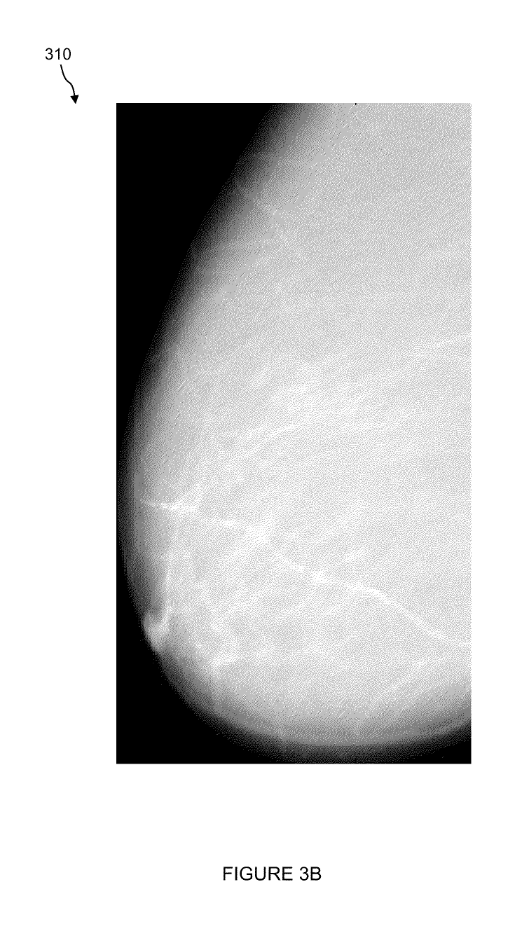

In certain embodiments, digital mammographic imagery acquired at step 210 may comprise a single digital mammographic image or “view” of an anatomical breast under study. For example, FIG. 3A illustrates an example of a craniocaudal (CC) image 300 of an anatomical breast. FIG. 3B illustrates an example of a mediolateral oblique (MLO) image 310 of an anatomical breast. These represent suitable, exemplary, single digital mammographic images in which to perform the breast density classification methods disclosed herein. Of course, the CC and MLO images in FIGS. 3A and 3B are exemplary only, and other individual breast images may be utilized by the methods and systems disclosed herein.

In certain other embodiments, the digital mammographic imagery acquired at step 210 may comprise a plurality of digital mammographic images or views of an anatomical breast under study. As will be further discussed hereinbelow, the density estimation of the anatomical breast may be improved by introducing information regarding the breast tissue as projected from different angles. For example, digital mammographic imagery acquired at step 210 may comprise both a CC image and a MLO image of an anatomical breast under study. By way of another example, digital mammographic imagery acquired at step 210 may comprise a plurality of digital tomographic mammography images of an anatomical breast, such as those that are acquired using a DBT imaging system. For example, DBT imaging systems may acquire 10 digital tomographic mammography images (i.e., “direct projection images” or “slices”) of a single anatomical breast composing digital mammographic imagery by moving a source at 4 degree increments around a plane. By way of yet another example, digital mammographic imagery acquired at step 210 may comprise a synthetic CC and a synthetic MLO mammographic image, both of which may be computed from a plurality of digital tomographic mammography images of an anatomical breast. Such synthetic mammographic imagery may be an advantageous way to visually present both the anatomical breast under study and the breast density classification data to radiologists who are accustomed to reviewing conventional CC and MLO mammography images, yet wish to realize the advantages of tomographic imaging procedures. Of course, the multiple views and images described herein are exemplary only, and other multiple breast images may be utilized by the methods and systems disclosed herein.

In yet certain other embodiments, digital mammographic imagery acquired at step 210 may comprise at least one image of an anatomical breast under study and at least one image of the patient's opposite breast. As will be further discussed herein below, the density estimation of an anatomical breast may be improved by studying the tissue of both breasts. For example, and not by way of limitation, the acquired digital mammographic imagery may comprise a CC and an MLO image of a patient's right anatomical breast and a CC and an MLO image of the patient's left anatomical breast.

There may be many other suitable ways known to persons of skill in the art to acquire digital mammographic imagery not presented by way of example in which the advantages of the disclosure may be achieved, and those are intended to be encompassed within this disclosure.

Digital mammographic imagery acquired at step 210 is then processed by image viewing station 110 at step 220 to compute breast density classification information associated with the anatomical breast under study. According to an embodiment of this disclosure, prior to computing breast density classification information at step 220, the digital mammographic imagery acquired at step 210 may be inverted or transformed to make tissue that attenuates more x-rays appear bright and tissue which x-rays pass through appear dark. The transformed imagery may also be sub-sampled so as to gain computational efficiencies without losing critical diagnostic information.

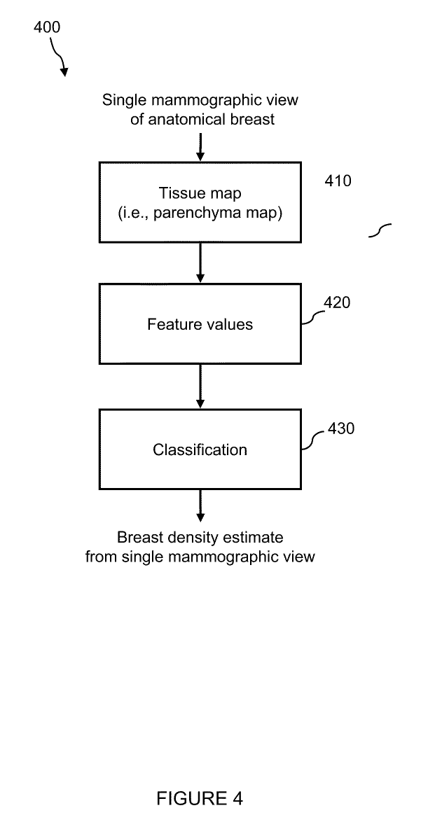

Referring now to FIG. 4, embodiments for computing breast density classification information at step 220 using a single digital mammographic image of the anatomical breast under study are presented. A tissue map may be formed from the single digital mammographic image at step 410 distinguishing fibro-glandular tissue (i.e., parenchyma) from fat tissue (i.e., non-parenchyma) in the anatomical breast under study. A plurality of feature values may then be calculated at step 420 from the tissue map formed at step 410 that characterize various features of the tissue in the anatomical breast. Classification step 430 assigns one of a plurality of breast density classes to the anatomical breast under study by comparing the plurality of feature values calculated at step 420 against classification parameters representing tissue characteristics of anatomical breasts of different densities. Other quantitative values associated with the density of the anatomical breast under study may also be computed at classification step 430.

An anatomical breast can be divided into two major tissue categories or components: fibro-glandular tissue and fat tissue. The density of an anatomical breast is described by the relative amount of fibro-glandular tissue present in the breast. Therefore, dense breasts will have more fibro-glandular tissue while fatty breasts will have less. The term “parenchyma” is used to describe the fibro-glandular tissue in digital mammographic imagery. The amount of parenchyma within a mammogram is directly proportional to the amount of fibro-glandular tissue present in the breast. Thus, highly accurate identification of the breast parenchyma is required in order to characterize the fibro-glandular breast tissue from fatty breast tissue.

Parenchyma will only appear within the actual anatomical breast, yet digital mammographic imagery acquired at step 210 will typically include areas outside of the anatomical breast region that are of diagnostic insignificance. Thus, according to an embodiment of the disclosure, image data representing the anatomical breast region may be first identified from other regions in the acquired digital mammographic imagery, such as but not limited to the foreground and background regions of the image. The anatomical breast region may be identified using any number of suitable automated image processing techniques, which are advantageous over requiring a radiologist or other user to manually identify such a region. One non-limiting example of a suitable image processing technique is a region growing method, such as, but not limited to, the acts disclosed in U.S. Pat. No. 6,091,841 “Method and system for segmenting desired regions in digital mammograms” assigned to Qualia Computing, Inc., which is incorporated herein by reference.

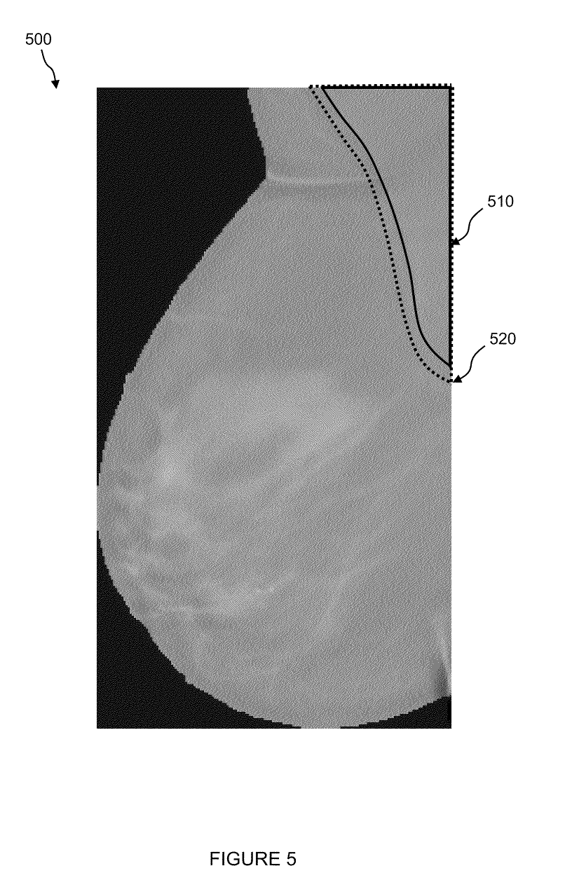

Some tissue of the anatomical breast may be obscured by the pectoral muscle in images taken at certain projection angles, such as in MLO images. Recognizing that it may be extremely difficult to distinguish the underlying nature of this breast tissue from the pectoral muscle due to the projection of the pectoral muscle tissue, according to an embodiment of the disclosure, image data representing the pectoral muscle may be identified and excluded from further analysis as potential breast parenchyma. The pectoral muscle may be identified using any number of suitable automated image processing techniques, which are advantageous over requiring a radiologist or other user to manually identify such a region. Several non-limiting examples of suitable image processing techniques include Hough transforms, self-organizing neural networks, Russ operators, and tunable parametric edge detection. Recognizing that such techniques may never be 100% accurate and that use of any of the pectoral muscle area in further analysis of breast parenchyma may be disadvantageous, according to a further embodiment of the disclosure, a boundary defining the areas between the breast and pectoral muscle may be thickened using, for example, a morphological operation. Other methods may be used. FIG. 5 illustrates an example of a MLO image of an anatomical breast under study. In this image, a pectoral muscle mask 510 is overlaid with a solid black line and a morphologically thickened pectoral muscle mask 520 is overlaid with a dashed black line, both of which may be computed in accordance with certain embodiments of this disclosure.

Tissue at the margin of a breast may not be as thick as the surrounding, compressed tissue and thus, the pixels along the margin may tend to “roll-off' or dim in the imagery. A visual example of this can be seen in FIGS. 3A and 3B. According to an embodiment of the disclosure, image data representing the margin may be identified and segmented from further analysis as potential breast parenchyma. In an alternate embodiment, rather than segment and exclude the margin from further analysis, the pixels of the margin may be corrected for thickness roll-off while leaving the underlying detail intact as is known in the art. FIG. 5 illustrates an example of a MLO image of an anatomical breast in which the pixels of the margin were corrected for thickness roll-off.

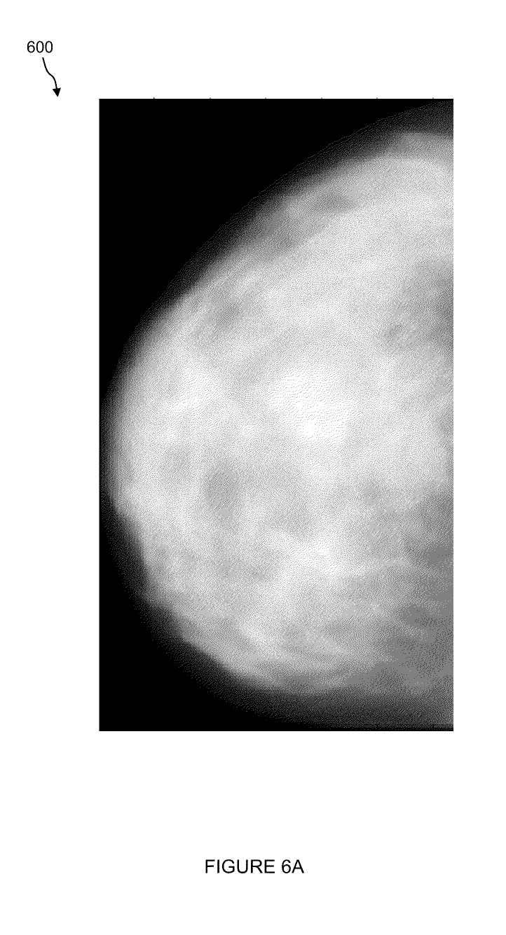

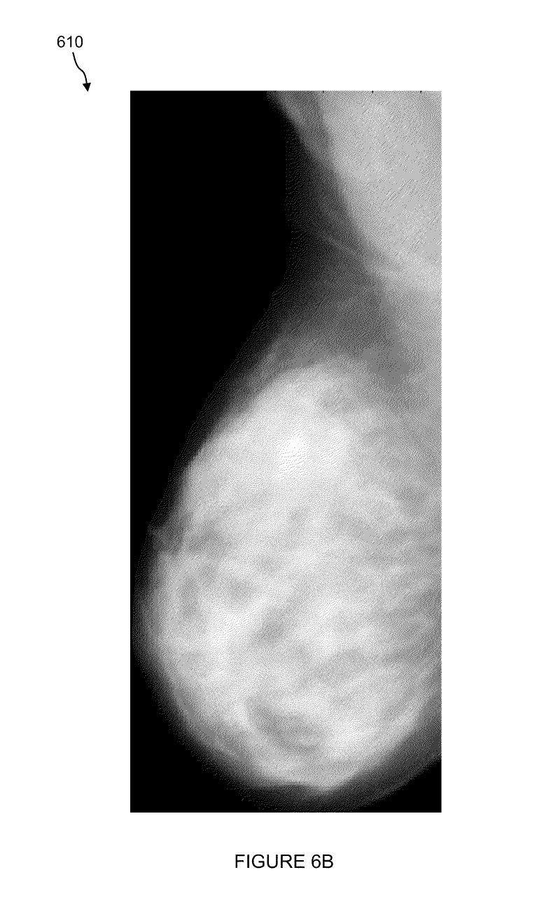

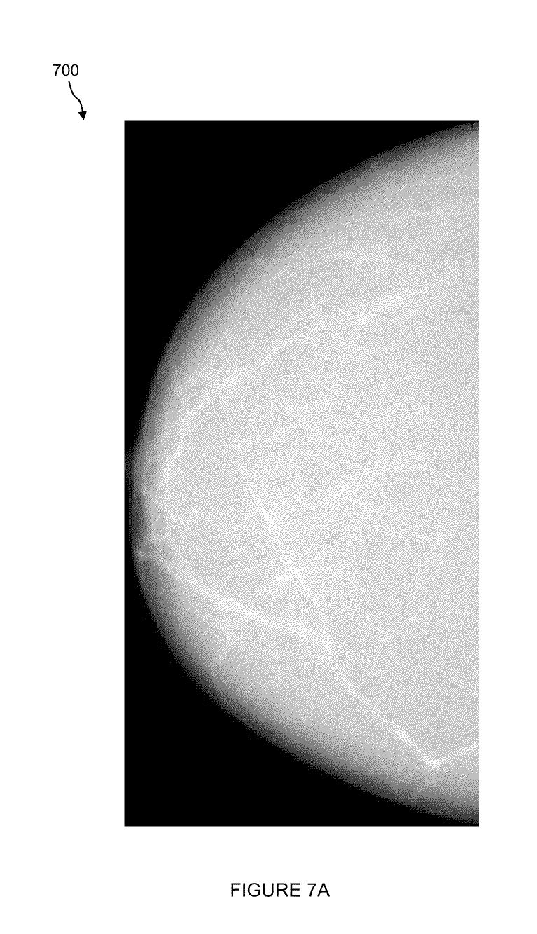

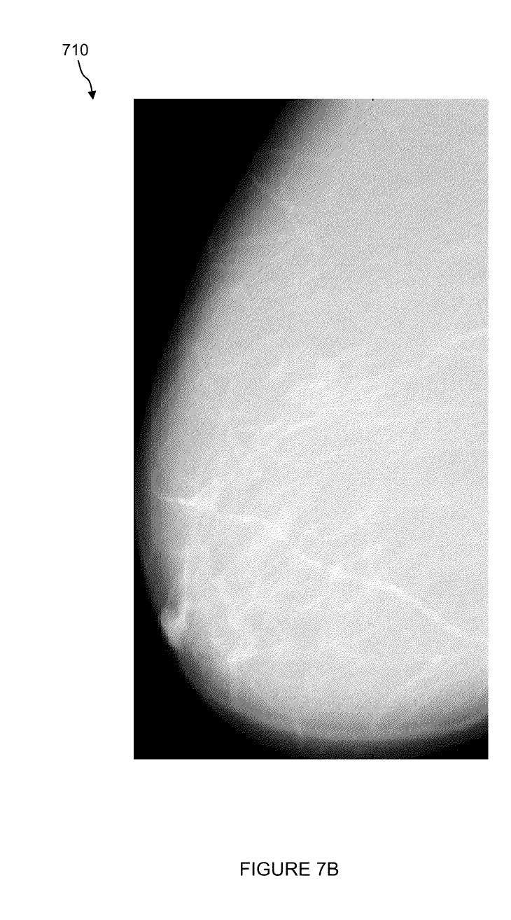

In dense breasts, an example of which is illustrated in FIGS. 6A and 6B, the parenchyma may appear very solid and homogenous. In fatty breasts, as example of which is illustrated in FIGS. 7A and 7B, the parenchyma may appear wispy and heterogeneous. Note that in the very fatty breast, the overall differences in intensities across the breast are more subtle than in the very dense breast, and may therefore be poor descriptors of different breast tissue. In contrast, however, note that texture is present in the fatty breast, and may therefore be a helpful descriptor of different breast tissue.

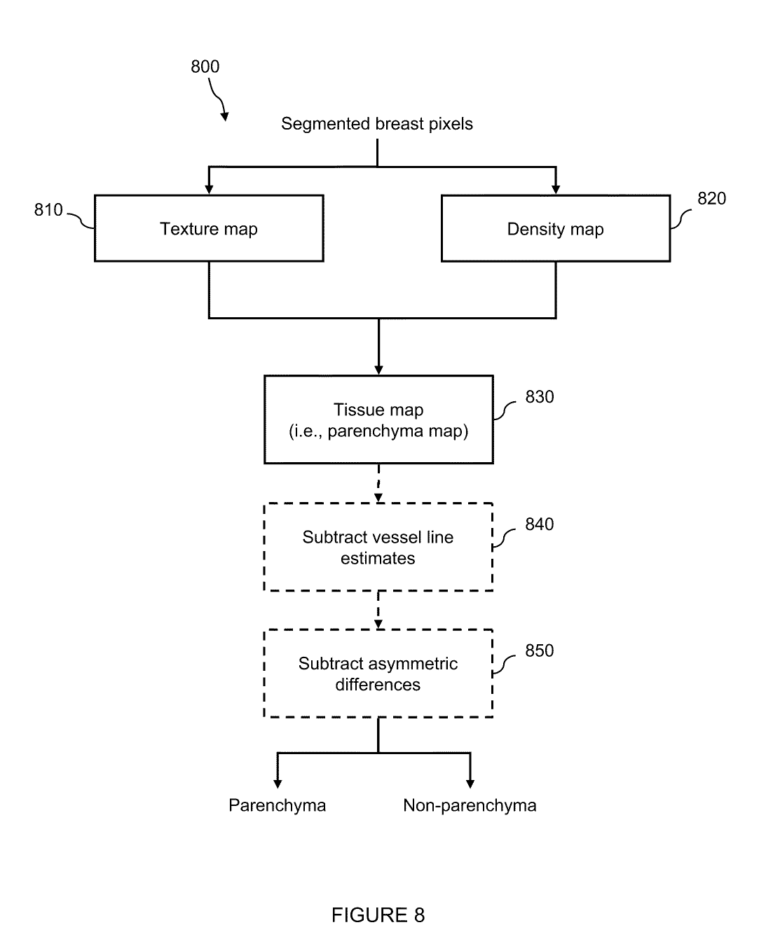

Referring now to FIG. 8, embodiments for forming a tissue map accurately characterizing the fibro-glandular tissue from fat tissue in a variety of breast types is presented. A texture map characterizing the texture of the anatomical breast under study may be formed at step 810. A density map characterizing the density of the anatomical breast under study may be formed at step 820. Information from both texture map and density map may then be combined to form a tissue map at step 830 that distinguishes the fibro-glandular tissue from fat tissue of the anatomical breast under study. Optionally, vessel lines segmented as part of the tissue map may be subtracted at step 840 to form a tissue map with a more accurate estimate of parenchyma. Optionally, an asymmetric comparison between tissue maps formed from different images of the patient's anatomical breast may be performed at step 850 to form a tissue map with a more accurate estimate of parenchyma.

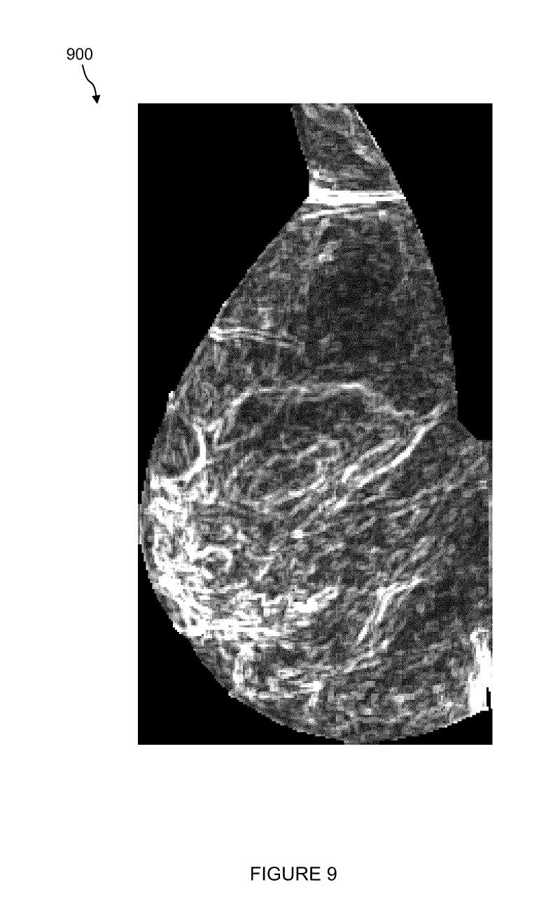

Turning first to the texture map created at step 810, according to an embodiment of the disclosure, the texture or wispiness of the anatomical breast under study may be characterized by measuring local changes in pixel intensities across the breast region, or at least a statistically significant portion of the breast region. Local regions of the breast with a high range of intensities indicate an area with significant texture or wispiness, while regions with a low range of intensities indicate a homogenous or non-wispy region. In certain embodiments, a range filter may be applied to the breast region to measure local changes in pixel intensities. The kernel size of the range filter may be chosen empirically, such that the filter effectively characterizes the fibro-glandular tissue expected to exhibit such texture or wispiness. A 3×3 kernel may suitably output both a maximum intensity value under the kernel and a minimum intensity value under the kernel, which may then be differenced to compute a single local intensity range at each pixel. Kernels of other sizes may also be used. Pixels with a significantly high intensity value (e.g., greater than 2 standard deviations above the mean intensity of all pixels under the kernel) may be normalized (e.g., to 2 standard deviations above the mean intensity of all pixels under the kernel) to normalize noise that may be incorrectly evaluated as wispy tissue. Other cutoffs than 2 standard deviations may be used. In other embodiments, a wavelet filter, a Gabor filter, a spatial grey-level dependence (SGLD) method, a Laws method, or a gradient analysis method may be applied to the breast region to measure local changes in pixel intensities and suitably characterize texture. Other methods known to persons of skill in the art also may be utilized to measure local changes in pixel intensities and suitably characterize texture, and the methods may be used singly or in combination. The response of each local region to the texture characterization may be represented in the form of the texture map created at step 810. FIG. 9 illustrates an example of a texture map 900 that was formed by performing the aforementioned range filter operations on a digital MLO mammographic image. Of course, other types of images may be used, and different texture characterization techniques may be used.

Turning next to the density map created at step 820, independent from characterizing the texture or wispiness of the anatomical breast under study, the density of the anatomical breast under study may be characterized by, according to another embodiment of the disclosure, measuring pixel intensity differences inside the breast region, or at least a statistically significant portion of the breast region. Breast pixels that have a relatively high intensity value when compared against an estimate of the background (i.e., fatty tissue) intensity value indicate regions with significant density.

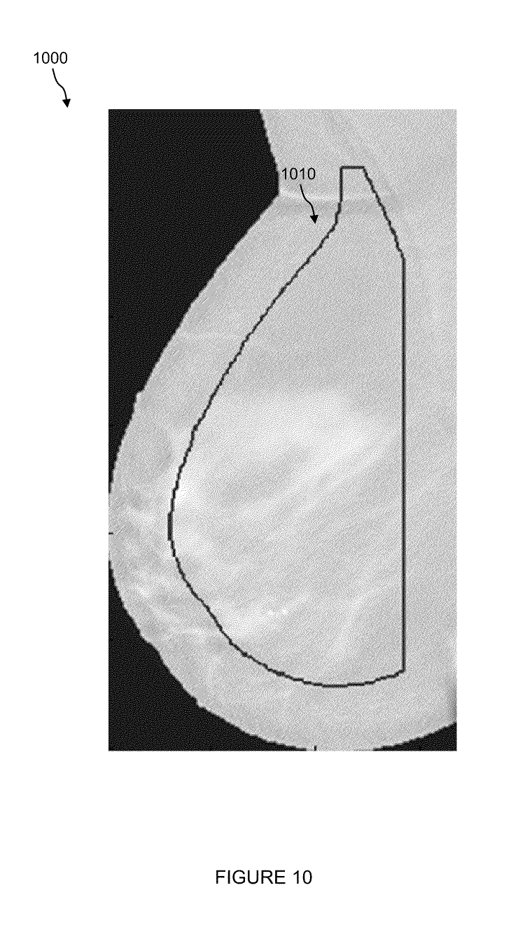

There are numerous ways of estimating the background intensity value inside the breast region. One way is to form a background value estimation region suspected to contain mostly fatty tissue and measure a global pixel intensity value from this region. According to an embodiment of the disclosure, a background value estimation region may be formed by thresholding a weighted distance map evaluated for pixels inside the breast region. Assuming a distance map is formed from the breast region, each pixel value may be normalized between 0 and 1 and then weighted by raising to 0.1 power. Then, pixel values may be thresholded at values greater than 0.9 to form a suitable background value estimation region containing mostly fatty breast tissue. FIG. 10 illustrates an example of a MLO image 1000 in which a background value estimation region 1010 was formed by performing the aforementioned operations. Background value estimation region 1010 is the breast region outside of the contour. A suitable background intensity value estimate may then be derived by computing the median value of pixels in this background value estimation region. Of course, more than one background value estimation region may be used, and other methods may be used to determine a background intensity value estimate, as will be known to persons of skill in the art.

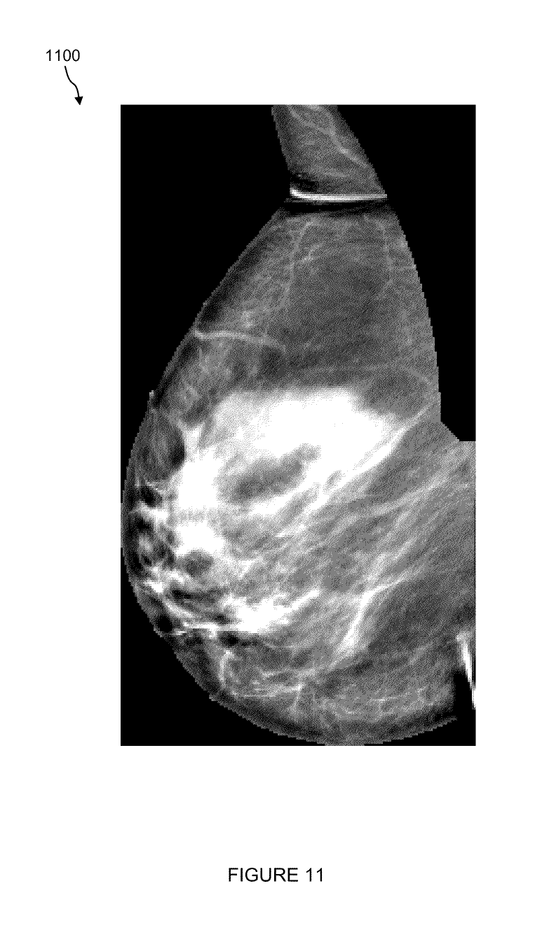

The background intensity value estimate may then be used to measure pixel intensity differences by forming an intensity difference image (i.e., an intensity difference map). According to an embodiment of the disclosure, a suitable intensity difference map may be formed by subtracting the computed background intensity value estimate from the value at each breast pixel. Negative values may be set to 0. To account for noise, breast pixels having difference values that are above two standard deviations above the mean may be set equal to two standard deviations above the mean. (Other values than two standard deviations may be used as cutoffs.) FIG. 11 illustrates an example of an intensity difference map 1100 that was formed by performing the aforementioned operations on a digital MLO mammographic image. Of course, other types of images may be used, and different techniques may be used to obtain an intensity difference map.

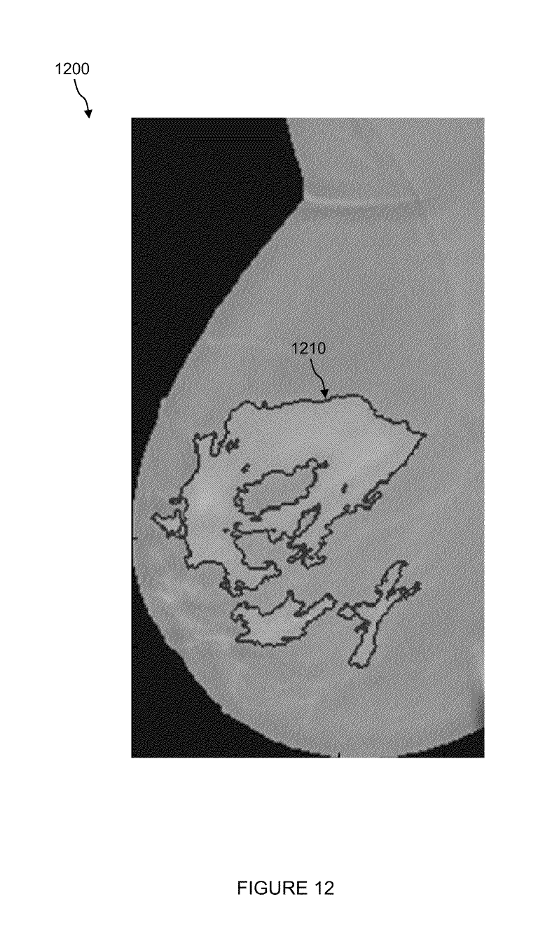

According to an embodiment of the disclosure, a binary thresholding operation may be performed on the intensity difference map to set each pixel to either a dense tissue pixel or a non-dense tissue pixel, thus forming a density map. The threshold may be dynamically set equal to the background intensity value estimate plus the standard deviation of the intensity of the breast region. Other cutoffs may be used. The response of each pixel to the thresholding operation may be represented in the form of the density map created at step 820. FIG. 12 illustrates an example of a density map 1200 containing a dense breast tissue region 1210 that was formed by performing the aforementioned operations on a digital MLO mammographic image, and drawing an outline around the selected area. Of course, other types of images may be used, and different techniques may be used to obtain a definition of the dense area.

In other embodiments of the disclosure, a suitable density map may be created at step 820 by modeling a histogram of the distribution of the gray-level pixel intensities inside the breast region and computing a threshold that separates an estimate of the dense parenchyma pixels from fatty pixels. For example, a Mixture of Gaussians algorithm may be performed that assumes a Gaussian distribution of higher intensity values represents dense tissue pixels and a Gaussian distribution of lower intensity values represents fatty tissue pixels.

In accordance with an embodiment of the disclosure, the texture information computed at step 810 may be input into the density map calculation at step 820 to further refine density estimates. For example, in embodiments where a Mixture of Gaussians algorithm may be performed, texture information may be input as a free variable or “dimension” into the Gaussian distribution estimate.

In accordance with further embodiments of the disclosure, the computed threshold used to separate fatty pixels from dense pixels may be compared against a background intensity or density estimate (e.g., extracted from the segmented chest wall area of the image). If the computed threshold is similar to the background estimate, this may indicate that the range in pixel intensity differences between fatty and dense tissue is minimal and that the breast under study is more likely to be entirely fatty or entirely dense. The results of such a comparison may be stored for later use and introduced (e.g., as a feature) into density classification estimates described herein below.

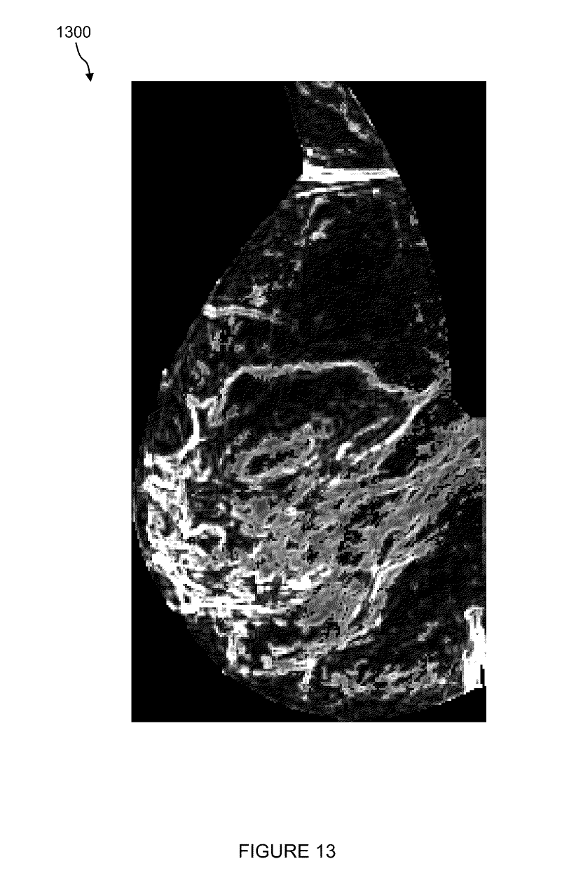

According to an embodiment of the disclosure, to emphasize range in darker tissue regions of the breast, the texture map created at step 810 may be re-weighted prior to combining texture and density information. This may be achieved, for example, by re-weighting pixels in said texture map in accordance with the inverted pixel values of the intensity difference map that may be used, in certain embodiments, to form the density map created at step 820 as described hereinabove. Empirically, it has been found that by re-weighing pixels of the texture map from step 810 that appear within an intensity range of 0.25-0.5 in the intensity difference map by a power of 0.75 and by re-weighting pixels of that texture map that do not appear within this intensity range in the intensity difference map by a power of 0.25, darker tissue regions of the breast may be suitably emphasized. FIG. 13 illustrates one example of a re-weighted texture map 1300 in which the re-weighting operations described hereinabove were performed to emphasize range on texture map 900. Of course, other reweighting techniques may be used.

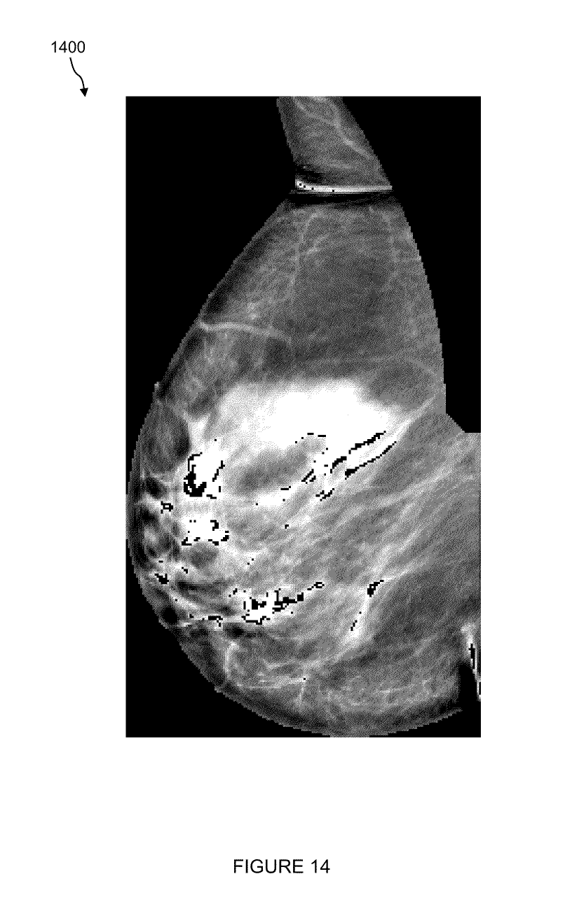

According to an embodiment of the disclosure, to emphasize areas of extreme denseness in the breast, the density map created at step 820 may be re-weighted prior to combining texture and density information. This may be achieved, for example, by re-weighting pixels in that density map in accordance with the thresholded pixel values of the intensity difference map that may be used, in certain embodiments, to form the density map created in step 820 as described hereinabove. Empirically, it has been found that by thresholding the intensity difference map at 0.975 and setting the pixels of that density map that are both in the thresholded intensity difference map and have less than a 0.4 intensity value in the texture map created in step 810, areas of extreme denseness can be suitably emphasized. FIG. 14 illustrates one example of a re-weighted density map 1400 in which the re-weighting operations described hereinabove were performed to emphasize areas of extreme denseness on density map 1200. Of course, other reweighting techniques may be used.

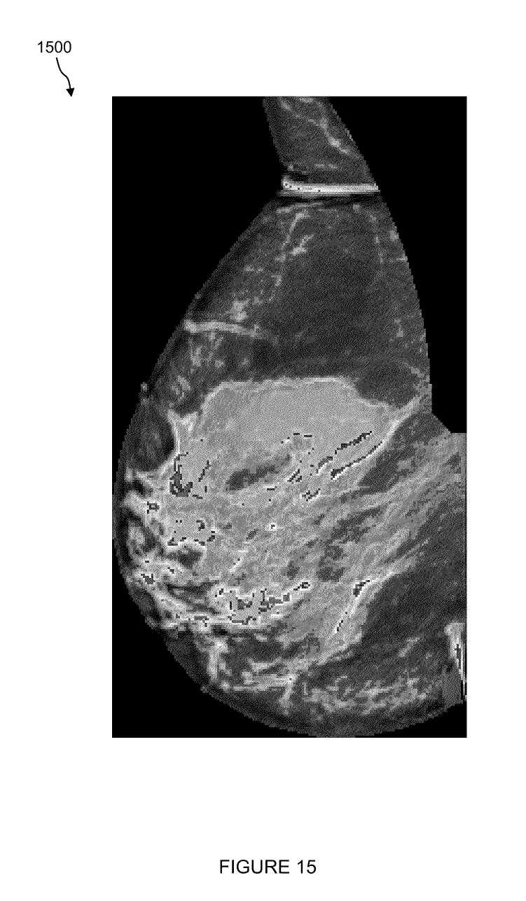

Having separately characterized the texture and density of the anatomical breast under study, information concerning both the texture in the texture map and the density in the density map may be combined to characterize a probability or likelihood whether each pixel in the breast region is representative of breast parenchyma and form a tissue map at step 830. According to an embodiment of the disclosure, because density may be a better overall descriptor than texture as to the nature of breast tissue, a probability map may be formed by linearly combining pixels of the texture map with a weight of 40% and pixels of the density map with a weight of 60%. FIG. 15 illustrates one example of a probability map 1500 in which the linear combination operations described hereinabove were performed. Of course, other relative weightings may be used.

Various rules may then be applied to characterize whether each pixel in the breast region is a parenchyma tissue pixel or a fatty (i.e., non-parenchyma) tissue pixel. According to an embodiment of the disclosure, a distance map may be used to set candidate parenchyma pixels towards the skin line to non-parenchyma (e.g., binary ‘0’) if the probability map also indicated a low likelihood (e.g., less than 0.4) that such pixels represent parenchyma tissue. This rule combines texture and density information with a distance to the breast skin line measurement to characterize fatty breast pixels. Of course, other likelihoods may be used as a cutoff, and other rules known to those of skill in the art may be applied.

A binary thresholding operation may be performed on the probability map to set each pixel to either a parenchyma tissue pixel or a non-parenchyma tissue pixel. Noting that the dynamic range of intensities in heterogeneous breasts will typically be greater than the dynamic range of intensities in homogenous breasts, according to an embodiment of the disclosure, the threshold value may be determined dynamically based on a measurement characterizing the area of denseness with respect to the total area of the breast. For example, if the area of density as represented by density map 820 is large when compared with the breast region (e.g., greater than 75% but less than 95%), there is less dynamic range in the image and a higher threshold value may be required for the system to characterize a pixel to be parenchyma tissue. For example, a threshold value of 0.65 may be used to label pixels in such breasts to either a parenchyma tissue pixel or a non-parenchyma tissue pixel; otherwise, a threshold value of 0.55 may be used. Of course, other values may be used as a threshold value, and other factors may be used to adjust the value. By using a dynamic threshold, a more accurate representation of the parenchyma and non-parenchyma tissue can be achieved.

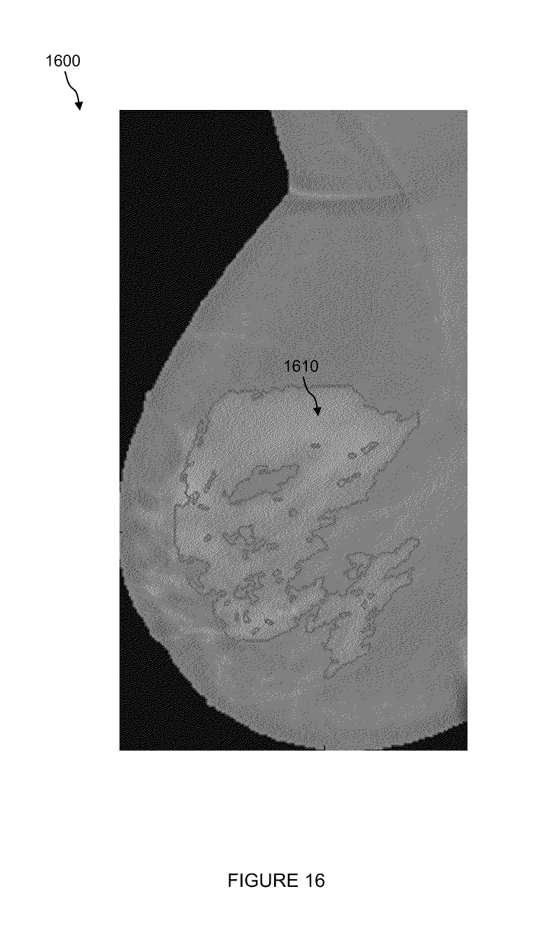

According to an embodiment of the disclosure, pixels representing small objects (e.g. less than 250 mm²) may also be set to 0 to avoid misclassifying small, high-intensity structures that may be pockets of parenchyma that are outside of the breast parenchyma disk or cancerous lesions. The latter may be required when testing the methods disclosed herein on samples of anatomical breasts having known cancerous lesions. Of course, other small-size cutoffs may be used. FIG. 16 illustrates an example of a tissue map 1600 in which the rules described hereinabove were performed on probability map 1500, and the parenchyma region 1610 is outlined. Note that tissue map 1600 distinguishes a parenchyma region 1610 characterizing the parenchyma or fibro-glandular tissue of the breast from the fat tissue of the breast. The fat tissue of the breast includes all pixels outside of parenchyma region 1610 that, in certain embodiments not illustrated in FIG. 16, may not include pixels of the pectoral muscle.

It has been found that in fatty breasts such as the breast illustrated in FIG. 3A and 3B, vessel lines are likely to be bright and very distinguishable from background tissue and thus, are frequently segmented as part of the parenchyma tissue map. However, these objects are not statistically reflective of the characteristics of the breast parenchyma and thus, when introduced into the density classification, may contribute to misclassification. In accordance with one embodiment of the disclosure, this problem may be dealt with by first detecting the vessel lines and then subtracting a mask of these objects from the computed parenchyma mask at step 840. Vessel lines may be detected from the breast region using any number of techniques such as, but not limited to, a steerable line filter algorithm.

It has also been found that when an anomaly such as a large cancer appears in the breast, these objects are also frequently segmented as part of the parenchyma tissue map. Such objects are also not statistically reflective of the characteristics of the breast parenchyma and thus, when introduced into the density classification, may contribute to misclassification. In accordance with one embodiment of the disclosure, this problem may be dealt with by comparing the parenchyma tissue map against a parenchyma tissue map extracted from another view of the patient's opposite breast at step 850. This process is typically called an asymmetric comparison. A region of parenchyma in one breast that exhibits substantially different characteristics from the corresponding parenchyma region in the other breast indicates a high likelihood that the region is likely an anomaly, not parenchyma. Such regions may be subtracted from the computed parenchyma tissue map before additional breast density classification processing is performed. In accordance with an embodiment of the disclosure, this step may be achieved by registering the single-view mammogram against a corresponding mammogram and performing a difference analysis (e.g., subtraction of one computed parenchyma tissue map from another map, followed by a thresholding operation) to compute asymmetric differences.

Again referencing FIG. 4, upon completion of the tissue map at step 410, the density of the breast tissue may then be characterized by extracting a plurality of feature values at step 420 based on the tissue map. Collectively, feature values may be considered a feature pool or a feature space of the breast tissue useful in characterizing the density of anatomical breasts. Some prior art breast density classification methods use a feature space to classify the density of an anatomical breast into one of two classes: a fatty breast class or a dense breast class. According to an embodiment of the disclosure, the anatomical breast may be classified to one of four breast density classes in accordance with the Breast Imaging Reporting and Data System (BI-RADS) guidelines as established by the American College of Radiology (ACR): entirely fatty breasts (0-25% glandular); scattered fibroglandular dense breasts (25-50% glandular); heterogeneously dense breasts (50-75% glandular); and extremely dense breasts (75-100% glandular). In such embodiments, a feature space of feature values that characterize both the fibro-glandular tissue and fat tissue may be computed at step 420 and utilized at classification step 430. Compared with other automated methods that form a feature space that characterizes only the fibro-glandular breast tissue or fatty breast tissue, the relationship between features of these tissue classes may thus be examined as a further way of characterizing the density of the breast under study. This is a technique that may more accurately classify the density of a wider variety of breast types and images encountered in clinical practice. Of course, the techniques set forth above also may be combined with conventional two-class classification schemes.

According to an embodiment of the disclosure, a histogram of intensity features of the tissue map formed at step 410 may be computed as part of calculating the plurality of feature values at step 420. For example, features describing the intensity of the non-parenchyma pixels may be computed such as, but not limited to, the dynamic range, the standard deviation, the skewness, and the kurtosis of the intensity of the non-parenchyma pixels. Ratio features describing the relationship between parenchyma and non-parenchyma pixel intensity features may be computed such as, but not limited to, the ratio of the median, the maximum, the minimum, and/or the standard deviation of the parenchyma pixel intensities to the ratio of the median, the maximum, the minimum, and/or the standard deviation of the non-parenchyma pixel intensities. Of course, values of other intensity characteristics may be utilized as well.

According to an embodiment of the disclosure, texture features of the tissue map formed at step 410 may be computed as part of determining the plurality of feature values at step 420. For example, features describing the intensity of the parenchyma pixels may be computed such as, but not limited to, the dynamic range, the standard deviation, the skewness, and the kurtosis of the intensity of the parenchyma pixels. A feature describing the number of “holes” in the image (i.e., regions of non-parenchyma that appear within the parenchyma region—may be set to a minimum number of pixels such as 5) may also be computed to characterize texture. Of course, values of other texture characteristics may be utilized as well.

According to an embodiment of the disclosure, shape or morphological features of the tissue map formed at step 410 may be computed as part of determining the plurality of feature values at step 420. For example, features describing the shape or morphology of the parenchyma pixel region may be computed such as, but not limited to, the number of parenchyma pixel region objects. Features describing the shape or morphology of the non-parenchyma pixels may be computed such as, but not limited to, the total area (i.e., size) of the non-parenchyma pixels. Ratio features describing the relationship between parenchyma and non-parenchyma pixel shape features may be computed such as, but not limited to, the ratio of the total area of the parenchyma to the non-parenchyma region and the ratio of the area of the parenchyma to the non-parenchyma region according to various quadrants (e.g., right, left, top, bottom) of the image. Of course, values of other morphological characteristics may be utilized as well.

Features known to a person of skill in the art, other than intensity features, texture features and shape or morphological features may be used.

At classification step 430, feature values calculated at step 420 are compared against classification parameters representing tissue characteristics of anatomical breasts of different densities. Such classification parameters may be stored in memory unit 124, for example. Based on this comparison, a breast density estimate is computed and assigned to the anatomical breast. The goal of classification is to group items that have similar feature values into groups and thus, the goal at classification step 430 is to group the anatomical breast under study into a density category based on feature values determined at step 420. According to embodiments of the present disclosure in which the anatomical breast may be classified to one of four breast density categories in accordance with ACR BI-RADS guidelines, the classification parameters stored in memory unit 124 represent feature characteristics of the tissue of entirely fatty breasts (0-25% glandular); scattered fibroglandular dense breasts (25-50% glandular); heterogeneously dense breasts (50-75% glandular); and extremely dense breasts (75-100% glandular). Of course, if only two classes are used for classification purposes, a suitable divide between the classes may be established, and classification systems utilizing other numbers of classes may also be used.

According to an embodiment of the disclosure, a plurality of different sets of classification parameters may be stored in memory unit 124. Each classification parameter set may correspond to the characteristics of anatomical breasts of various densities as imaged from a particular image angle. For example, and not by way of limitation, a set of classification parameters derived from CC images of anatomical breasts of different densities may be selected to classify feature values extracted from a CC image, while a set of classification parameters derived from MLO images of anatomical breasts of different densities may be selected to classify feature values extracted from a MLO image. By way of another example, again not by way of limitation, each classification parameter set may correspond to the characteristics of anatomical breasts of various densities as imaged from a specific digital tomographic mammography imaging angle (i.e., “a direct projection angle”) and/or by a specific imaging technique. Dynamic selection of classification parameters may be advantageous because certain fibro-glandular and/or fat tissue characteristics may be more descriptive based on the angle from which the anatomical breast is imaged, and/or the imaging technique used. For example, it has been found that the ratio of median intensity values between fibro-glandular and fat tissue may be a descriptive feature in characterizing breast tissue in CC images. It has also been found that the number of regions segmented as part of the parenchyma may be a descriptive feature in characterizing scattered fibroglandular dense breasts from heterogeneously dense breasts in MLO images. These feature characteristics are merely presented as examples. Different feature characteristics may be more descriptive if the anatomical breast is characterized at different angles, different projection depths, or different resolutions, for example, or if different types of images are analyzed.

According to certain embodiments, the image content may be analyzed to automatically derive information associated with the angle at which the anatomical breast is projected (e.g., whether the image is a CC or a MLO view). For example, and not by way of limitation, three features may be computed on the segmented breast region: the ratio of the width of the top of the segmented breast region to the overall width of the segmented breast region; an error estimate that indicates how well the breast region contour is fit by a parabola; and the fractional overlap of the top and bottom portions of the segmented breast region when a map or mask of the region is “folded over” at the widest row of the breast region. The first feature may be used because CC view masks are typically much narrower at the top than are MLO view masks. The second feature may be used because CC view masks tend to have a parabolic shape, while MLO view masks usually have a more complicated shape. The third feature may be used because CC view masks typically are much more symmetric about the horizontal line containing the widest part of the mask than are MLO view masks. After computing the three features, a two-class difference-of-discriminants classifier may be applied to the feature data to decide whether the image is a CC view or an MLO view. A CC is class 1, and has a non-negative difference of discriminants, and an MLO is class 0, and has a negative difference of discriminants. The algorithm may use the breast direction and the CC-MLO classification result to classify CC or MLO view and/or right or left breast. Alternatively, other techniques may be used to decide if the image is a CC or MLO, or other, view. Alternatively, parameters associated with the image may be read from a file header associated with the digital mammography imagery acquired at step 210 and used to select an appropriate set of classification parameters from memory at classification step 430.

According to an embodiment of the disclosure, a decision tree classifier may be employed at classification step 430 to compare the classification parameters retrieved from storage against feature values calculated at step 420 and, based on this comparison, compute and assign a breast density class for the anatomical breast. Decision tree classifiers may be advantageous in that they may correctly classify breast density with a substantially high accuracy while at the same time, the rules used to achieve such classification are simple to understand and interpret. Thus, a physician who may be interested in understanding the behavior of the breast density classification system and methods disclosed herein may benefit from such classifiers. However, any number of classification algorithms or combination of classification algorithms (e.g., committees) known in the art such as, but not limited to, a linear classifier, a quadratic classifier, a neural network classifier, a decision-tree classifier, a fuzzy logic classifier, a support vector machine (SVM) classifier, a Bayesian classifier, a k-nearest neighbor classifier, or a syntactical classifier may also be used to perform classification 430. (See Pattern Classification, Duda et al., John Wiley & Sons, New York, October 2000.)

According to an embodiment of the disclosure, the classification rules presented below may be performed on CC digital mammographic images. However, these are provided by way of non-limiting example only. Other rules may be sued for such images, and for other images the actual classification rules that may be developed will depend on the combination of sample digital mammographic images, feature values, and classification algorithm or algorithm(s) implemented for performing classification step 430.

By way of non-limiting example, for CC digital mammographic images a ratio feature value describing the median intensity values of parenchyma to non-parenchyma breast pixels may be used in combination with, for example, features describing the distribution (e.g., the standard deviation or the kurtosis) of intensity values of the parenchyma pixels alone and/or non-parenchyma pixels alone in distinguishing an entirely fatty breast (BI-RADS density category 1) from a scattered fibro-glandular dense breast (BI-RADS density category 2). Entirely fatty breasts will exhibit either a low distribution of parenchyma pixel intensity values or a high distribution of non-parenchyma pixel intensity values, while scattered fibro-glandular dense breasts will typically exhibit the opposite behavior. A high median intensity ratio feature used in combination with, for example, low intensity skewness features of both parenchyma and non-parenchyma breast pixels may be useful in distinguishing an extremely dense breast (BI-RAD density category 4) from other types of breasts.

According to an embodiment of the disclosure, the classification rules presented below may be performed on MLO digital mammographic images. However, these are also provided by way of non-limiting example only. Other rules may be used for such images. If the kurtosis distribution of intensity features of both the parenchyma and non-parenchyma pixels are both lower than predetermined classification thresholds, the breast may be classified as a dense breast (BI-RADS density categories 3 and 4). A skewness distribution of intensity features of the non-parenchyma pixels may further be compared against a predetermined threshold in which if the threshold is not met, the breast may be classified as an extremely dense breast (BI-RADS density category 4) and if the threshold is met, the breast may be classified as a heterogeneously dense breast (BI-RADS density category 3). If the kurtosis distribution of intensity feature of the non-parenchyma pixels is lower than the predetermined classification threshold and the kurtosis distribution of intensity feature of the parenchyma pixels is higher than the predetermined classification threshold, additional classification may be performed to determine breast density. For example, a skewness distribution of intensity features of the non-parenchyma pixels may further be compared against a predetermined threshold in which if the threshold is not met, the breast may be classified as extremely dense (BI-RADS density category 4) and if the threshold is met, the breast may be classified as a fatty breast (BI-RADS density categories 1 and 2). The ratio of the total area of the non-parenchyma pixels to parenchyma pixels may be compared against a predetermined threshold in which if the threshold is not met, the breast may be classified as entirely fatty (BI-RADS density category 1) and if the threshold is met, the breast may be classified as a scattered fibro-glandular density (BI-RADS density category 2).

According to an embodiment of the disclosure, the classifier may be designed such that both a “hard” and “soft” breast density classification decision is computed at classification step 430, or such that only a “hard” or a “soft” classification decision is made. The “hard” breast density classification decision may indicate one breast density category in accordance with the BI-RADS guidelines described hereinabove). The “soft” breast density classification decision may indicate a probability (e.g., on a 0-100% scale) or degree to which the breast under study exhibits the characteristics of a dense or fatty breast. This probability may be expressed as a percentage describing the amount of fibro-glandular or glandular tissue, which may be determined based on the percentage area of parenchyma with respect to the percentage area of the breast. Alternatively, the amount of fibro-glandular or glandular tissue may be further based upon the “hard” breast density classification decision output by the classifier. For example, if the computed percentage describing the amount of fibro-glandular or glandular tissue is 50% and the classifier density output is a scattered fibro-glandular dense breast (BI-RADS density category 2), a final percentage glandular tissue output may be 39%, which is half-way between the percentage ranges encompassed within this BI-RADS density category. Alternatively, if the classifier density output is a scattered fibro-glandular dense breast (BI-RADS density category 2), a distance measurement (e.g., the Mahalanobis distance) may be used to measure the similarity between the features of the anatomical breast under study and the features of anatomical breasts labeled to the same BI-RADS density category to compute a final percentage glandular tissue estimate.

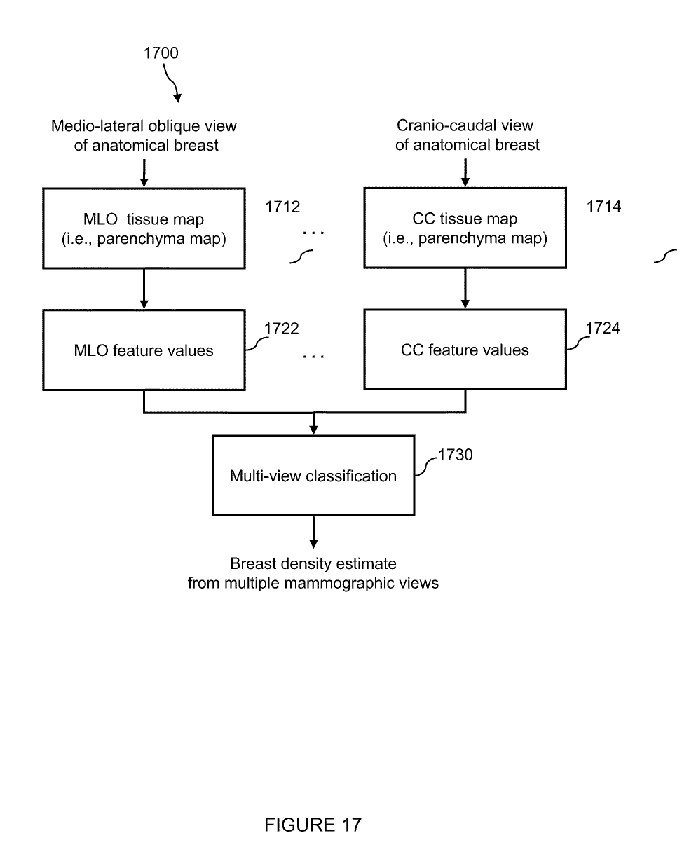

Referring now to FIG. 17, embodiments for computing breast density classification information at step 220 using a plurality of digital mammographic images of an anatomical breast under study are presented. A plurality of tissue maps distinguishing fibro-glandular tissue (i.e., parenchyma) from fat tissue (i.e., non-parenchyma) in the anatomical breast under study may be identified from a plurality of digital mammographic images acquired at step 210, whereby each map characterizes the breast tissue at a specific angle, a specific projection depth, a specific resolution, etc. For example, depending on the angle at which the breast is projected, the tissue may superimpose differently in each image and thus, better discrimination between dense and fat tissue in the breast may be achieved by processing these multiple tissue maps. For example, by way of a non-limiting example presented in FIG. 17, in embodiments where a MLO and a CC image of the anatomical breast are acquired as digital mammographic imagery at step 210, a MLO tissue map 1712 may be formed from the MLO image and a CC tissue map 1714 may be formed from the CC image. In accordance with such embodiments, MLO tissue map 1712 may be formed from a MLO image by performing the acts described hereinabove with reference to FIG. 4 and CC tissue map 1714 may be formed from a CC image by also performing the acts described hereinabove with reference to FIG. 4. In other embodiments, a plurality of tissue maps may be created from a plurality of direct projections, each map corresponding to the tissue of the anatomical breast imaged at the direct projection angle. In general, a plurality of maps may be created corresponding to the initially-acquired digital imagery.

A plurality of feature sets may then be calculated that characterize the fibro-glandular tissue and fat tissue in each tissue map. This may be advantageous because certain fibro-glandular tissue and/or fat tissue characteristics may be more descriptive based on the angle from which the anatomical breast is imaged. For example, by way of a non-limiting example presented in FIG. 17, in embodiments where a MLO tissue map 1712 and a CC tissue map 1714 may be formed, a MLO feature set 1722 and a CC feature set 1724 may be computed from each respective tissue map. In accordance with such embodiments, MLO feature set 1722 may be computed from MLO tissue map 1712 by performing the acts described hereinabove with reference to FIG. 4 and CC feature set 1724 may be formed from CC image 1714 by also performing the acts described hereinabove with reference to FIG. 4. In other embodiments, a plurality of feature sets may be extracted from a plurality of tissue maps created from a plurality of direct projections, each feature set or feature space characterizing the tissue of the anatomical breast imaged at the direct projection angle. In general, a plurality of feature sets may be created corresponding to the tissue maps derived from the initially-acquired digital imagery.

At multi-view classification step 1730, the plurality of feature sets are then compared against a single set of classification parameters stored in memory unit 124 and based on this comparison, a breast density estimate is computed and assigned to the anatomical breast. Note that at multi-view classification step 1730, in contrast to classification step 430, the classification parameters in the single set represent characteristics of the fibro-glandular and fat tissue of anatomical breasts of different densities as imaged from a plurality of angles or image sources. For example, features and classification parameters describing the intensity of the fibro-glandular breast tissue from both the CC and MLO views, when taken together, may be more descriptive of the actual breast tissue than features and classification parameters describing such tissue from a single image view alone. Features and classification parameters describing the intensity of the fibro-glandular breast tissue using a plurality of projection views acquired using tomography may be more descriptive of the actual breast tissue than features acquired from a single image view.

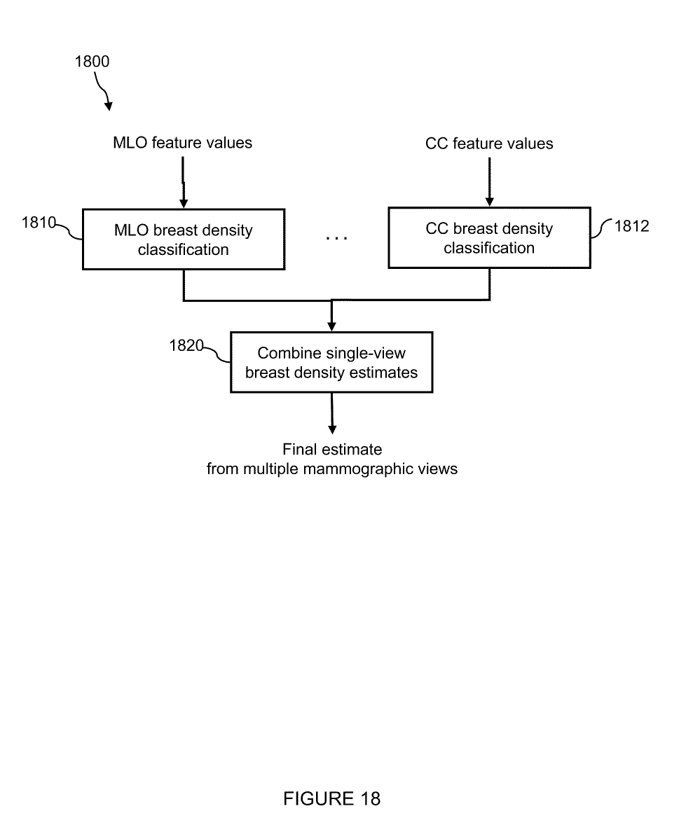

FIG. 18 illustrates an alternate embodiment of acts that may be performed at multi-view classification step 1730. In embodiments illustrated in FIG. 18, a plurality of breast density classification estimates are computed independently in accordance with the plurality of computed feature sets, whereby each breast density classification estimate is determined in accordance with a specific feature set and a specific classification parameter set. For example, in embodiments where an MLO feature set may be determined at step 1722 and a CC feature set at step 1724 from respective tissue maps, an MLO breast density classification estimate may be computed at step 1810 from the MLO feature set determined at step 1722 by performing the acts described hereinabove with reference to FIG. 4. Separately, a CC breast density classification estimate may be computed at step 1812 from the CC feature set determined at step 1724 by performing the acts described hereinabove with reference to FIG. 4. According to one embodiment of the disclosure, the CC and MLO breast density classification estimates, which may be characterized as single-view estimates, may be expressed in the form of a percentage estimate as to the glandular tissue of the anatomical breast as determined in a specific image. Alternately, single-view estimates may be expressed in the form of a numerical identifier corresponding to one of a plurality of breast density classification categories, such as the BI-RADS categories described hereinabove.

Then, a case-based breast density estimate may be computed at step 1820 for the anatomical breast by statistically combining the individual, single-view breast density estimates. According to an embodiment of the disclosure, the mode of the single-view breast density estimates may be computed and assigned as the case-based breast density estimate at step 1820. If the modes are equal, the mean of the breast density estimates may be computed and assigned as the case-based breast density estimate. In further embodiments of the disclosure, a suitable case-based breast density estimate may be assigned by selecting the minimum or the maximum single-view breast density estimates, or by utilizing any technique known to persons of skill in the art to obtain a best estimate from a group of estimates. Any such exemplary computations may be made to integrate the breast density classification information from multiple images to arrive at a breast density estimate that is more accurate than an estimate that is solely derived from a single mammographic image.

Thus, using additional mammographic images of the same anatomical breast improves the accuracy in which density can be estimated. Breast density classification information may also be computed at step 220 by performing the acts described in FIG. 17 and FIG. 18 using at least one image of an anatomical breast under study and at least one image of the patient's opposite breast, which may result in further improvements in which breast density can be estimated. It was empirically determined over several studies that classification of breast density into the correct BI-RADS category could be increased by approximately 5-7% when two digital images of the anatomical breast under study (the CC and MLO images) and two digital images of the patient's opposite breast (also the CC and MLO images) were used instead of a single digital image of the anatomical breast under study. It was realized, based on the results of this study, that misclassifications may be further reduced by applying the methods disclosed herein to a plurality of digital medical images of an anatomical breast acquired using tomographic imaging techniques such as digital breast tomosynthesis (DBT). For example, tissue density information computed from plural tomographic projection images or plural tomographic reconstructed slices of an anatomical breast may yield a more accurate overall characterization of the physical density of the anatomical breast tissue than traditional mammography.

At output step 230, breast density classification information determined at step 220 may be transferred in the form of data to memory unit 124 for storage so that it can be retrieved at a later time by a radiologist or other user of system 100. Alternatively, breast density classification information determined at step 220 may be automatically output via output interface 128 to GUI 140 in the form of a report, as part of an image, or other visual depiction means that enables a radiologist or other user of system 100 to understand that the breast density classification information represents the density of the anatomical breast under study.

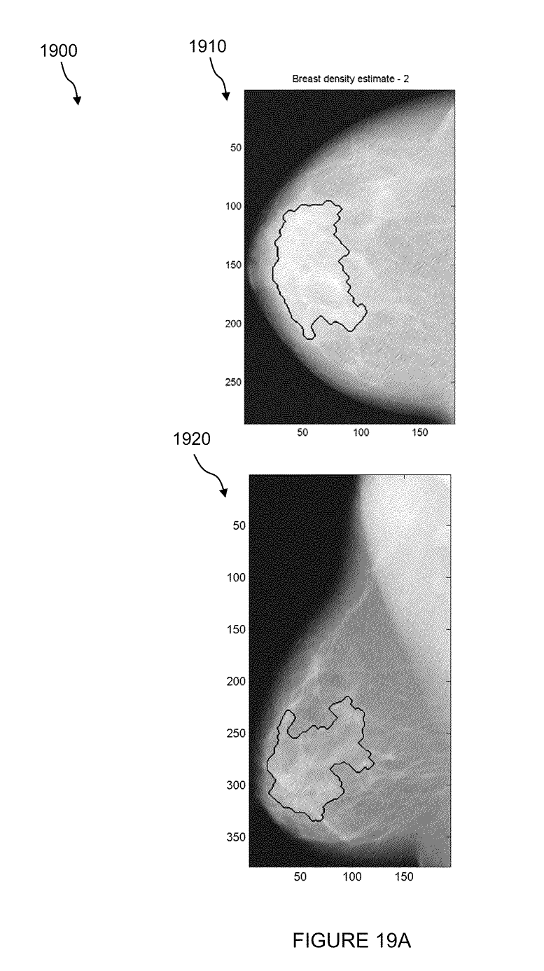

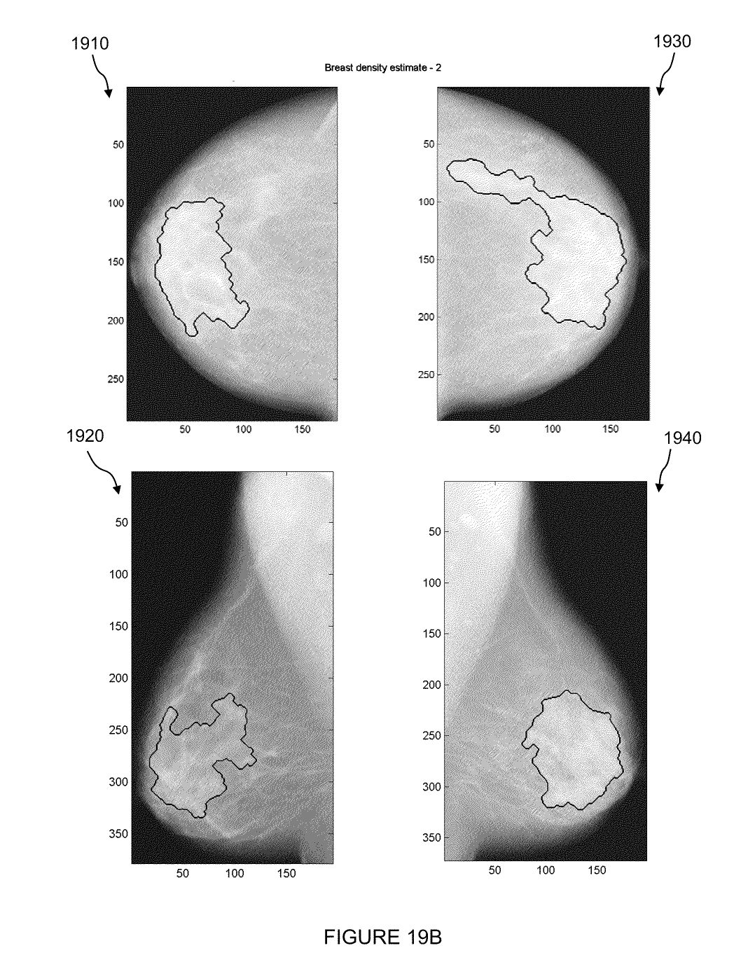

FIG. 19A is one example of breast density classification information that may be output along with at least one image of the anatomical breast under study on GUI 140. Information pertaining to the breast density classification estimate obtained by processing both a CC image 1910 of an anatomical breast and a MLO image 1920 of the anatomical breast may be output. This example was chosen because the methods described herein independently classified the density of the anatomical breast depicted in FIG. 19A using CC image 1910 as scattered fibroglandular densities (class 2) and the density of the anatomical breast depicted in FIG. 19A using MLO image 1920 as entirely fat (class 1). A radiologist reported this anatomical breast as a scattered fibroglandular density. By classifying the anatomical breast using information from both images, the breast density classification system was able to correctly classify this image as a scattered fibroglandular density.

FIG. 19B shows an alternate embodiment where the correct classification was further supported by introducing imagery of the opposite breast, namely CC image 1930 and MLO image 1940, both of which were also classified as scattered fibroglandular densities. Any such imagery may be further output along with the breast density classification information on GUI 140 to allow interpretation by a radiologist. In other embodiments, a computed percentage glandular tissue estimate as described hereinabove may also be presented.

Having described the systems, computer-readable media, and methods disclosed herein in detail and by reference to specific embodiments thereof, it will be apparent that modifications and variations are possible without departing from the scope of this disclosure. More specifically, although some aspects of this disclosure may be identified herein as preferred or particularly advantageous, it is contemplated that the methods and systems disclosed herein are not necessarily limited to these preferred aspects.

1. A computer-readable medium having computer-readable instructions stored thereon which, as a result of being executed in a computer system having at least one input device, at least one processor and at least one output device, instructs the computer system to perform a method to compute and output a density estimate of a breast, comprising:
a. obtaining, by means of at least one input device, at least two digital images of at least a portion of the breast, wherein each image represents a view of at least a portion of the breast from a specific angle;
b. computing, in at least one processor, a breast density estimate using information from the at least two digital images,; and
c. outputting, by means of at least one output device, the computed density estimate.

2. The computer-readable medium of claim 1 wherein computing the breast density estimate comprises:
b1, in at least one processor, for each digital image, computing at least one feature value;
b2. in at least one processor, for each digital image, computing an image breast density estimate using computed image feature values; and
b3. in at least one processor, computing the breast density estimate using computed image breast density estimates.

3. The computer-readable medium of claim 2, wherein:
at least one digital image is a two-dimensional CC digital image and at least one digital image is a two-dimensional MLO digital image; and
at least one image breast density estimate is computed by means of a cranio-caudal (CC) computer-based classifier, using computed image feature values of a CC digital image, and at least one image breast density estimate is computed by means of a medio-lateral oblique (MLO) computer-based classifier, using computed image feature values of a MLO digital image.

4. The computer-readable medium of claim 3 wherein the CC computer-based classifier comprises feature values that distinguish breasts of different densities projected from a cranio-caudal angle and the MLO computer-based classifier comprises feature values that distinguish breasts of different densities projected from a medio-lateral oblique angle.

5. The computer-readable medium of claim 2, wherein:
the at least two digital images of the breast are tomographic images; and
each image breast density estimate is computed by means of a tomographic image computer-based classifier, using computed image feature values of a tomographic digital image.

6. The computer-readable medium of claim 5 wherein each tomographic computer-based classifier comprises feature values that distinguish breasts of different densities projected from a specific tomographic angle.

7. The computer-readable medium of claim 1 wherein computing the breast density estimate comprises:
b1, in at least one processor, for each digital image, computing at least one feature value; and
b2. in at least one processor, computing the breast density estimate using computed image feature values.

8. The computer-readable medium of claim 1 wherein computing the breast density estimate further comprises using information from at least one digital image of at least a portion of a breast opposite to the breast.

9. The computer-readable medium of claim 1 wherein at least one digital image represents a two-dimensional CC view of at least a portion of the breast, and at least one digital image represents a two-dimensional MLO view of at least a portion of the breast.

10. The computer-readable medium of claim 1 wherein the images are tomographic images of at least a portion of the breast.

11. The computer-readable medium of claim 1, wherein the computed density estimate comprises an estimate of whether the breast belongs to at least one of four predetermined breast density categories of entirely fatty, scattered fibro-glandular dense, heterogeneously dense, and extremely dense breasts.

12. In a computer system having at least one input device, at least one processor and at least one output device, a method of computing and outputting a density estimate of a breast, comprising:
a. obtaining, by means of at least one input device, at least two digital images of at least a portion of the breast, wherein each image represents a view of at least a portion of the breast from a specific angle;
b. computing, in at least one processor, a breast density estimate using information from the at least two digital images,; and
c. outputting, by means of at least one output device, the computed density estimate.

13. The method of claim 12 wherein computing the breast density estimate comprises:
b1, in at least one processor, for each digital image, computing at least one feature value;
b2. in at least one processor, for each digital image, computing an image breast density estimate using computed image feature values; and
b3. in at least one processor, computing the breast density estimate using computed image breast density estimates.

14. The method of claim 13, wherein:
at least one digital image is a two-dimensional CC digital image and at least one digital image is a two-dimensional MLO digital image; and
at least one image breast density estimate is computed by means of a cranio-caudal (CC) computer-based classifier, using computed image feature values of a CC digital image, and at least one image breast density estimate is computed by means of a medio-lateral oblique (MLO) computer-based classifier, using computed image feature values of a MLO digital image.

15. The method of claim 14 wherein the CC computer-based classifier comprises feature values that distinguish breasts of different densities projected from a cranio-caudal angle and the MLO computer-based classifier comprises feature values that distinguish breasts of different densities projected from a medio-lateral oblique angle.

16. The method of claim 13, wherein:
the at least two digital images of the breast are tomographic images; and
each image breast density estimate is computed by means of a tomographic image computer-based classifier, using computed image feature values of a tomographic digital image.

17. The method of claim 16 wherein each tomographic computer-based classifier comprises feature values that distinguish breasts of different densities projected from a specific tomographic angle.

18. The method of claim 12 wherein computing the breast density estimate comprises:
b1, in at least one processor, for each digital image, computing at least one feature value; and
b2. in at least one processor, computing the breast density estimate using computed image feature values.

19. The method of claim 12 wherein computing the breast density estimate further comprises using information from at least one digital image of at least a portion of a breast opposite to the breast.

20. The method of claim 12 wherein at least one digital image represents a two-dimensional CC view of at least a portion of the breast, and at least one digital image represents a two-dimensional MLO view of at least a portion of the breast.

21. The method of claim 12 wherein the images are tomographic images of at least a portion of the breast.

22. The method of claim 12, wherein the computed density estimate comprises an estimate of whether the breast belongs to at least one of four predetermined breast density categories of entirely fatty, scattered fibro-glandular dense, heterogeneously dense, and extremely dense breasts.

23. A system for computing and outputting a density estimate of a breast, comprising a computer system with at least one processor, at least one input device and at least one output device, so configured that the system is operable to:
a. obtain, by means of at least one input device, at least two digital images of at least a portion of the breast, wherein each image represents a view of at least a portion of the breast from a specific angle;
b. compute, in at least one processor, a breast density estimate using information from the at least two digital images,; and
c. output, by means of at least one output device, the computed density estimate.

24. The system of claim 23 wherein computing the breast density estimate comprises:
b1, in at least one processor, for each digital image, computing at least one feature value;
b2. in at least one processor, for each digital image, computing an image breast density estimate using computed image feature values; and
b3. in at least one processor, computing the breast density estimate using computed image breast density estimates.

25. The system of claim 24, wherein:
at least one digital image is a two-dimensional CC digital image and at least one digital image is a two-dimensional MLO digital image; and
at least one image breast density estimate is computed by means of a cranio-caudal (CC) computer-based classifier, using computed image feature values of a CC digital image, and at least one image breast density estimate is computed by means of a medio-lateral oblique (MLO) computer-based classifier, using computed image feature values of a MLO digital image.

26. The system of claim 25 wherein the CC computer-based classifier comprises feature values that distinguish breasts of different densities projected from a cranio-caudal angle and the MLO computer-based classifier comprises feature values that distinguish breasts of different densities projected from a medio-lateral oblique angle.

27. The system of claim 24, wherein:
the at least two digital images of the breast are tomographic images; and
each image breast density estimate is computed by means of a tomographic image computer-based classifier, using computed image feature values of a tomographic digital image.

28. The system of claim 27 wherein each tomographic computer-based classifier comprises feature values that distinguish breasts of different densities projected from a specific tomographic angle.

29. The system of claim 23 wherein computing the breast density estimate comprises:
b1, in at least one processor, for each digital image, computing at least one feature value; and
b2. in at least one processor, computing the breast density estimate using computed image feature values.

30. The system of claim 23 wherein computing the breast density estimate further comprises using information from at least one digital image of at least a portion of a breast opposite to the breast.

31. The system of claim 23 wherein at least one digital image represents a two-dimensional CC view of at least a portion of the breast, and at least one digital image represents a two-dimensional MLO view of at least a portion of the breast.

32. The system of claim 23 wherein the images are tomographic images of at least a portion of the breast.

33. The system of claim 23, wherein the computed density estimate comprises an estimate of whether the breast belongs to at least one of four predetermined breast density categories of entirely fatty, scattered fibro-glandular dense, heterogeneously dense, and extremely dense breasts.

34. A computer-readable medium having computer-readable instructions stored thereon which, as a result of being executed in a computer system having at least one input device, at least one processor and at least one output device, instructs the computer system to perform a method to compute and output a density estimate of a breast, comprising:
a. obtaining, by means of at least one input device, at least one digital image of at least a portion of the breast, wherein each image represents a view of at least a portion of the breast from a specific angle;
b. obtaining, by means of at least one input device, at least one digital image of at least a portion of a breast opposite to the breast, wherein each image represents a view of at least a portion of the opposite breast from a specific angle;
c. computing, in at least one processor, a breast density estimate using information from the at least one digital breast image and at least one digital opposite breast image; and
d. outputting, by means of at least one output device, the computed density estimate.

35. The computer-readable medium of claim 34 wherein computing the breast density estimate comprises:
b1, in at least one processor, for each digital breast image, computing at least one feature value using the said digital breast image and a digital opposite breast image;
b2. in at least one processor, for each digital breast image, computing an image breast density estimate using computed image feature values; and
b3. in at least one processor, computing the breast density estimate using computed image breast density estimates.

36. The computer-readable medium of claim 34 wherein computing the breast density estimate comprises:
b1. in at least one processor, for each digital breast image, computing at least one feature value using the said digital breast image and a digital opposite breast image; and
b2. in at least one processor, computing the breast density estimate using computed image feature values.

37. The computer-readable medium of claim 34 further comprising performing an asymmetrical subtraction of information relating to the digital opposite breast image from information relating to the digital breast image.

38. The computer-readable medium of claim 34 wherein at least one digital breast image represents a two-dimensional CC view of at least a portion of the breast, and at least one digital breast image represents a two-dimensional MLO view of at least a portion of the breast.

39. The computer-readable medium of claim 34 wherein the digital breast images are tomographic images of at least a portion of the breast

40. The computer-readable medium of claim 34, wherein the computed density estimate comprises an estimate of whether the breast belongs to at least one of four predetermined breast density categories of entirely fatty, scattered fibro-glandular dense, heterogeneously dense, and extremely dense breasts.

41. In a computer system having at least one input device, at least one processor and at least one output device, a method of computing and outputting a density estimate of a breast, comprising:
a. obtaining, by means of at least one input device, at least one digital image of at least a portion of the breast, wherein each image represents a view of at least a portion of the breast from a specific angle;
b. obtaining, by means of at least one input device, at least one digital image of at least a portion of a breast opposite to the breast, wherein each image represents a view of at least a portion of the opposite breast from a specific angle;
c. computing, in at least one processor, a breast density estimate using information from the at least one digital breast image and at least one digital opposite breast image; and
d. outputting, by means of at least one output device, the computed density estimate.

42. The method of claim 41 wherein computing the breast density estimate comprises:
b1, in at least one processor, for each digital breast image, computing at least one feature value using the said digital breast image and a digital opposite breast image;
b2. in at least one processor, for each digital breast image, computing an image breast density estimate using computed image feature values; and
b3. in at least one processor, computing the breast density estimate using computed image breast density estimates.

43. The method of claim 41 wherein computing the breast density estimate comprises:
b1. in at least one processor, for each digital breast image, computing at least one feature value using the said digital breast image and a digital opposite breast image; and
b2. in at least one processor, computing the breast density estimate using computed image feature values.

44. The method of claim 41 further comprising performing an asymmetrical subtraction of information relating to the digital opposite breast image from information relating to the digital breast image.

45. The method of claim 41 wherein at least one digital breast image represents a two-dimensional CC view of at least a portion of the breast, and at least one digital breast image represents a two-dimensional MLO view of at least a portion of the breast.

46. The method of claim 41 wherein the digital breast images are tomographic images of at least a portion of the breast

47. The method of claim 41, wherein the computed density estimate comprises an estimate of whether the breast belongs to at least one of four predetermined breast density categories of entirely fatty, scattered fibro-glandular dense, heterogeneously dense, and extremely dense breasts.

48. A system for computing and outputting a density estimate of a breast, comprising a computer system with at least one processor, at least one input device and at least one output device, so configured that the system is operable to:
a. obtain, by means of at least one input device, at least one digital image of at least a portion of the breast, wherein each image represents a view of at least a portion of the breast from a specific angle;
b. obtain, by means of at least one input device, at least one digital image of at least a portion of a breast opposite to the breast, wherein each image represents a view of at least a portion of the opposite breast from a specific angle;
c. compute, in at least one processor, a breast density estimate using information from the at least one digital breast image and at least one digital opposite breast image; and
d. output, by means of at least one output device, the computed density estimate.

49. The system of claim 48 wherein computing the breast density estimate comprises:
b1, in at least one processor, for each digital breast image, computing at least one feature value using the said digital breast image and a digital opposite breast image;
b2. in at least one processor, for each digital breast image, computing an image breast density estimate using computed image feature values; and
b3. in at least one processor, computing the breast density estimate using computed image breast density estimates.

50. The system of claim 48 wherein computing the breast density estimate comprises:
b1. in at least one processor, for each digital breast image, computing at least one feature value using the said digital breast image and a digital opposite breast image; and
b2. in at least one processor, computing the breast density estimate using computed image feature values.

51. The system of claim 48, wherein the system is further configured to be operable to perform an asymmetrical subtraction of information relating to the digital opposite breast image from information relating to the digital breast image.

52. The system of claim 48 wherein at least one digital breast image represents a two-dimensional CC view of at least a portion of the breast, and at least one digital breast image represents a two-dimensional MLO view of at least a portion of the breast.

53. The system of claim 48 wherein the digital breast images are tomographic images of at least a portion of the breast

54. The system of claim 48, wherein the computed density estimate comprises an estimate of whether the breast belongs to at least one of four predetermined breast density categories of entirely fatty, scattered fibro-glandular dense, heterogeneously dense, and extremely dense breasts.

55. A medical imaging system, comprising:
a. a source configured to obtain digital images of breasts;
b. a processor coupled with the source configured to compute a density estimate of a breast using information from at least two digital images, wherein a first digital image represents a view of at least a portion of the breast from a specific angle and wherein a second digital image is chosen from a group consisting of a further view of at least a portion of the breast from a second specific angle, and a view of at least a portion of an opposite breast from the specific angle; and
c. an output device coupled with the processor configured to output the computed density estimate.

56. The medical imaging system of claim 55 wherein the source is configured to obtain a plurality of tomographic images of at least a portion of the breast and the processor is configured to compute the density estimate using tomographic images.

57. The medical imaging system of claim 56 wherein the processor is further configured to compute a plurality of reconstructed slices from the plurality of tomographic images and to compute the density estimate using reconstructed slices.

58. A computer-readable medium having computer-readable instructions stored thereon which, as a result of being executed in a computer system having at least one input device, at least one processor and at least one output device, instructs the computer system to perform a method to compute and output a density estimate of a breast, comprising:
a. obtaining, by means of at least one input device, at least one digital image of at least a portion of the breast;
b. computing, in at least one processor, parenchyma information relating to the breast using texture information and density information derived from the at least one digital image;
c. computing, in at least one processor, a breast density estimate using computed parenchyma information; and
d. outputting, by means of at least one output device, the computed density estimate.

59. The computer-readable medium of claim 58 wherein the parenchyma information is computed for individual pixels of the digital image.

60. The computer-readable medium of claim 58 wherein parenchyma information for a specific area of the breast is computed based in part on the location of the area in the breast.

61. The computer-readable medium of claim 58 wherein density information is given a stronger weighting than texture information in computing parenchyma information.

62. The computer-readable medium of claim 58 wherein the parenchyma information is computed further using texture information and density information derived from at least one digital image of at least a portion of an opposite breast.

63. The computer-readable medium of claim 58, further comprising segmenting a digital representation of at least a portion of the breast into breast parenchyma and breast non-parenchyma using computed parenchyma information.

64. The computer-readable medium of claim 63 wherein the digital representation is segmented by thresholding the computed parenchyma information.

65. The computer-readable medium of claim 63 wherein the breast density estimate is computed using feature values of segmented breast parenchyma.

66. The computer-readable medium of claim 63 wherein the breast density estimate is computed further using feature values of segmented breast non-parenchyma.

67. The computer-readable medium of claim 58 wherein the breast density estimate is computed using feature values of computed parenchyma information

68. The computer-readable medium of claim 58, wherein the computed density estimate comprises an estimate of whether the breast belongs to at least one of four predetermined breast density categories of entirely fatty, scattered fibro-glandular dense, heterogeneously dense, and extremely dense breasts.

69. In a computer system having at least one input device, at least one processor and at least one output device, a method of computing and outputting a density estimate of a breast, comprising:
a. obtaining, by means of at least one input device, at least one digital image of at least a portion of the breast;
b. computing, in at least one processor, parenchyma information relating to the breast using texture information and density information derived from the at least one digital image;
c. computing, in at least one processor, a breast density estimate using computed parenchyma information; and
d. outputting, by means of at least one output device, the computed density estimate.

70. The method of claim 69 wherein the parenchyma information is computed for individual pixels of the digital image.

71. The method of claim 69 wherein parenchyma information for a specific area of the breast is computed based in part on the location of the area in the breast.

72. The method of claim 69 wherein density information is given a stronger weighting than texture information in computing parenchyma information.

73. The method of claim 69 wherein the parenchyma information is computed further using texture information and density information derived from at least one digital image of at least a portion of an opposite breast.

74. The method of claim 69, further comprising segmenting a digital representation of at least a portion of the breast into breast parenchyma and breast non-parenchyma using computed parenchyma information.

75. The method of claim 74 wherein the digital representation is segmented by thresholding the computed parenchyma information.

76. The method of claim 74 wherein the breast density estimate is computed using feature values of segmented breast parenchyma.

77. The method of claim 74 wherein the breast density estimate is computed further using feature values of segmented breast non-parenchyma.

78. The method of claim 69 wherein the breast density estimate is computed using feature values of computed parenchyma information

79. The method of claim 69, wherein the computed density estimate comprises an estimate of whether the breast belongs to at least one of four predetermined breast density categories of entirely fatty, scattered fibro-glandular dense, heterogeneously dense, and extremely dense breasts.

80. A system for computing and outputting a density estimate of a breast, comprising a computer system with at least one processor, at least one input device and at least one output device, so configured that the system is operable to:
a. obtain, by means of at least one input device, at least one digital image of at least a portion of the breast;
b. compute, in at least one processor, parenchyma information relating to the breast using texture information and density information derived from the at least one digital image;
c. compute, in at least one processor, a breast density estimate using computed parenchyma information; and
d. output, by means of at least one output device, the computed density estimate.

81. The system of claim 80 wherein the parenchyma information is computed for individual pixels of the digital image.

82. The system of claim 80 wherein parenchyma information for a specific area of the breast is computed based in part on the location of the area in the breast.

83. The system of claim 80 wherein density information is given a stronger weighting than texture information in computing parenchyma information.

84. The system of claim 80 wherein the parenchyma information is computed further using texture information and density information derived from at least one digital image of at least a portion of an opposite breast.

85. The system of claim 80, wherein the system is further configured to be operable to segment a digital representation of at least a portion of the breast into breast parenchyma and breast non-parenchyma using computed parenchyma information.

86. The system of claim 85 wherein the digital representation is segmented by thresholding the computed parenchyma information.

87. The system of claim 85 wherein the breast density estimate is computed using feature values of segmented breast parenchyma.

88. The system of claim 85 wherein the breast density estimate is computed further using feature values of segmented breast non-parenchyma.

89. The system of claim 80 wherein the breast density estimate is computed using feature values of computed parenchyma information

90. The system of claim 80, wherein the computed density estimate comprises an estimate of whether the breast belongs to at least one of four predetermined breast density categories of entirely fatty, scattered fibro-glandular dense, heterogeneously dense, and extremely dense breasts.

91. A computer-readable medium having computer-readable instructions stored thereon which, as a result of being executed in a computer system having at least one input device, at least one processor and at least one output device, instructs the computer system to perform a method to compute and output a density estimate of a breast, comprising:
a. obtaining, by means of at least one input device, at least one digital image of at least a portion of the breast;
b. computing, in at least one processor, vessel line information from the at least one digital image;
c. computing, in at least one processor, parenchyma information from the at least one digital image, using computed vessel line information;
d. computing, in at least one processor, a breast density estimate using computed parenchyma information; and
e. outputting, by means of at least one output device, the computed density estimate.

92. The computer-readable medium of claim 91 wherein parenchyma information is computed by means of treating computed vessel line information as non-parenchyma.

93. In a computer system having at least one input device, at least one processor and at least one output device, a method of computing and outputting a density estimate of a breast, comprising
a. obtaining, by means of at least one input device, at least one digital image of at least a portion of the breast;
b. computing, in at least one processor, vessel line information from the at least one digital image;
c. computing, in at least one processor, parenchyma information from the at least one digital image, using computed vessel line information;
d. computing, in at least one processor, a breast density estimate using computed parenchyma information; and
e. outputting, by means of at least one output device, the computed density estimate.

94. The method of claim 93 wherein parenchyma information is computed by means of treating computed vessel line information as non-parenchyma.

95. A system for computing and outputting a density estimate of a breast, comprising a computer system with at least one processor, at least one input device and at least one output device, so configured that the system is operable to:
a. obtain, by means of at least one input device, at least one digital image of at least a portion of the breast;
b. compute, in at least one processor, vessel line information from the at least one digital image;
c. compute, in at least one processor, parenchyma information from the at least one digital image, using computed vessel line information;
d. compute in at least one processor, a breast density estimate using computed parenchyma information; and
e. output, by means of at least one output device, the computed density estimate.

96. The system of claim 95 wherein parenchyma information is computed by means of treating computed vessel line information as non-parenchyma.
